(19) United States
(12) Patent Application Publication
(10) Pub. No.: US 2026/0290313 A1
(43) Pub. Date: Sep. 24, 2026

(54) SYSTEM

(71) Applicant: SoftBank Group Corp., Tokyo (JP)

(72) Inventor: Risa SAKURABA, Tokyo (JP)

(73) Assignee: SoftBank Group Corp., Tokyo (JP)

(21) Appl. No.: 19/565,613

(22) Filed: Mar. 13, 2026

(30) Foreign Application Priority Data
Mar. 19, 2025 (JP) 2025-045016

(51) Int. Cl. G10L 13/047; G06F 40/295; G06N 3/0475

(52) U.S. Cl. CPC G10L 13/047; G06F 40/295; G06N 3/0475

(57) ABSTRACT

A system includes a processor that is configured to generate audio that imitates cheering of a crowd, analyze generated audio and convert the generated audio into a digital format, and receive, as an input, a prompt for instructing generation of audio data and generate the audio data based on the prompt.

### CROSS-REFERENCE TO RELATED APPLICATION

This application is based on and claims priority under 35 USC 119 from Japanese Patent Application No. 2025-045016 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

In large-scale events such as sports games, concerts, and live performances, it is often desirable to enhance the sense of excitement and immersion by using cheering sounds of a crowd. However, conventional systems mainly rely on pre-recorded cheering audio or simple looped sound effects, which lack flexibility and do not adequately adapt to the specific situation, script, or scenario of the event. Furthermore, such systems do not allow an operator or another system to dynamically instruct, in natural language or other high-level prompts, what type of cheering audio should be generated. As a result, the produced audio is often monotonous, does not adequately reflect the intended atmosphere, and fails to provide an optimal sound quality when reproduced in various event venues having different acoustic environments. Therefore, there is a need for a system that can automatically generate audio that imitates cheering of a crowd based on an input prompt, convert and process the generated audio as digital data, and adjust acoustic characteristics to provide optimal sound quality in a given venue, thereby improving both controllability and realism of cheering audio reproduction.

### SUMMARY

To solve the above-described problems, according to one aspect of the present invention, there is provided a system comprising a processor. The processor is configured to generate audio that imitates cheering of a crowd, analyze the generated audio and convert the generated audio into a digital format, and receive, as an input, a prompt for instructing generation of audio data and generate the audio data based on the prompt. In certain embodiments, the processor is further configured to analyze an input prompt sentence by using a natural language processing technique and to generate the audio data based on a result of the analysis, thereby allowing an operator or another system to specify, in natural language, desired characteristics of cheering audio, such as intensity, emotional tone, or duration. In additional embodiments, the processor is configured to adjust acoustic characteristics when the generated audio data is reproduced at an event venue so as to provide an optimal sound quality, for example by applying equalization, dynamic range control, reverberation, or other sound field corrections matched to the acoustic properties of the venue. By these means, the system enables flexible, prompt-driven generation of crowd-cheering audio and adaptive optimization of its reproduction in various event environments.

The term “system” refers to an arrangement of one or more hardware and software components that cooperate to perform the processing described in the claims, including at least a processor and optionally memory, storage, input/output interfaces, and communication interfaces.

The term “processor” refers to any circuitry or processing unit capable of executing instructions, performing arithmetic or logical operations, and controlling other components, and may include a central processing unit (CPU), a graphics processing unit (GPU), a digital signal processor (DSP), a microcontroller, or a combination thereof.

The term “audio” refers to sound signals, including analog or digital representations of sound waves, that are perceptible to human hearing or are intended to be reproduced as such.

The term “cheering of a crowd” refers to sound produced by a plurality of people expressing excitement, support, or enthusiasm, including shouts, applause, whistles, and other vocal or percussive sounds typically occurring in event venues.

The term “generate audio that imitates cheering of a crowd” refers to producing, by electronic or computational means, audio signals that simulate or reproduce characteristics of real crowd cheering, regardless of whether the audio is synthesized, processed from source samples, or created by combining multiple sound elements.

The term “analyze generated audio” refers to processing audio signals to extract one or more characteristics or parameters, such as amplitude, frequency components, temporal structure, or other features, for the purpose of conversion, classification, transformation, or further processing.

The term “digital format” refers to a representation of audio as discrete numerical values, such as pulse-code modulation (PCM) samples, compressed audio data, or other digitized forms suitable for storage, processing, or transmission by digital systems.

The term “convert the generated audio into a digital format” refers to transforming audio signals into a digital representation, including operations such as sampling, quantization, encoding, or re-encoding, so that the audio can be handled as digital data.

The term “prompt” refers to an input expression, command, instruction, or description, which may be provided in natural language or other formats, and which specifies or influences the content, style, or characteristics of audio data to be generated.

The term “prompt for instructing generation of audio data” refers to a prompt that includes information or directives indicating what type of audio data should be generated, such as desired mood, intensity, duration, or other attributes of the cheering audio.

The term “audio data” refers to data representing audio in digital form, including raw sample data, encoded or compressed audio files, or any structured data suitable for playback or further processing as sound.

The term “input prompt sentence” refers to a prompt expressed as one or more sentences, typically in natural language, that describe or request particular properties or scenarios of the cheering audio to be generated.

The term “natural language processing technique” refers to any computational method or algorithm for analyzing, interpreting, or transforming human language input, including but not limited to tokenization, parsing, semantic analysis, intent recognition, or machine learning models applied to text.

The term “acoustic characteristics” refers to properties of audio signals that affect perceived sound quality or sound field, including but not limited to volume, frequency balance, reverberation, dynamic range, spatial distribution, and other parameters related to the auditory experience.

The term “event venue” refers to any physical location at which an event involving an audience is held, such as a stadium, arena, hall, theater, concert venue, or similar facility where audio is reproduced for attendees.

The term “optimal sound quality” refers to a state in which the reproduced audio is adjusted to be appropriate for the acoustic environment and intended experience of the audience, taking into account factors such as clarity, loudness, intelligibility, balance, and listener comfort.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

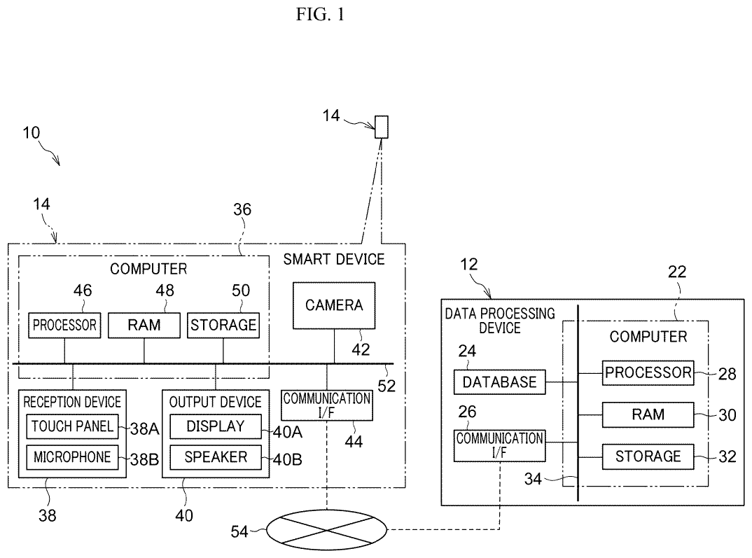

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

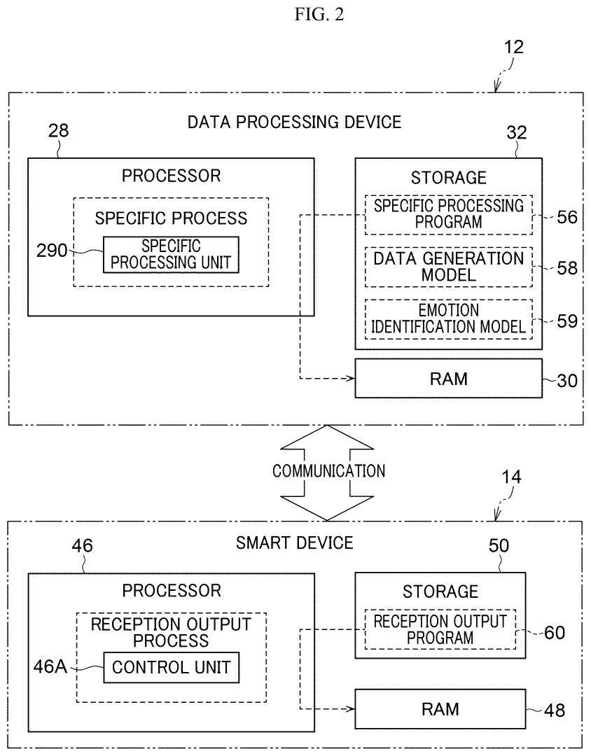

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional crowd-sound playback systems used in large-scale events typically rely on pre-recorded audio clips or simple mixing of limited sound samples. Such systems are constrained in their ability to dynamically adapt the cheering sound to the semantic intent of an operator's instructions, such as the type of event, the timing within the event, or the desired emotional intensity. In many cases, an operator must manually search for, select, and trigger audio files, which results in latency, inconsistent sound quality, and an inability to fine-tune the acoustic characteristics for different venues.

Furthermore, existing audio generation systems that use machine learning often treat text input and audio output as loosely coupled stages and do not perform end-to-end optimization that incorporates both deep semantic analysis of prompt sentences and detailed signal processing tuned to the acoustic field of a target reproduction space. As a result, even when a generative model is used, the generated cheering audio may exhibit artificial artifacts, suboptimal loudness, or inappropriate spectral balance when reproduced through large-scale sound reinforcement equipment. This leads to increased computational waste due to repeated trial-and-error generation and manual post-processing, and it limits the practical deployment of such systems in real-time event environments.

In addition, many known systems do not fully exploit structured condition information, such as event type, temporal transitions, audience reaction type, and emotional intensity, as control parameters of a generative AI model. The absence of such structured control reduces the precision with which the system can generate temporally evolving crowd reactions, such as gradually rising cheers or context-specific applause. Consequently, existing approaches do not sufficiently improve the underlying computer technology for generating, processing, and delivering complex crowd audio in response to natural language input, and they fail to provide a technically efficient pipeline from text prompt to venue-optimized audio output.

Accordingly, there is a need for an improved computer-implemented system that integrates (i) semantic analysis of prompt sentences, (ii) controlled operation of a generative AI model for producing cheering audio signals, and (iii) venue-aware digital signal processing and encoding, in order to increase computational efficiency, reduce manual intervention, and automatically produce high-quality cheering audio that is optimized for playback in various acoustic environments.

The specific processing by the specific processing unit 290 of the data processing device 12 in Example 1 is realized by the following means.

The present invention provides a server comprising a processor configured to receive, via a communication path, request information including a prompt sentence and associated condition information from a user terminal, the prompt sentence being accepted as character information and the request information being structured based on the prompt sentence, to preprocess the prompt sentence included in the request information by using natural language processing to convert the prompt sentence into a token sequence and numerical representation and to supply the token sequence and the numerical representation, as generation input data, to a generative artificial intelligence model, to execute the generative artificial intelligence model on an information processing apparatus to generate, based on the generation input data, an audio signal including acoustic waveform data corresponding to a crowd cheer by machine learning and to acquire the audio signal as digital audio data, to apply a signal processing algorithm to the audio data to analyze at least one of frequency characteristics, sound pressure level, dynamic range, and noise components and to execute at least one of filtering processing, dynamic range compression processing, equalization processing, noise reduction processing, and volume normalization processing so as to generate processed audio data whose acoustic quality is corrected, to encode the processed audio data in accordance with a predetermined encoding scheme or to convert the processed audio data into a storage format and to transmit, to the user terminal, response information including the processed audio data and attribute information of the processed audio data, and to output the processed audio data in a format capable of being supplied to an acoustic output apparatus provided by the user terminal so as to radiate, via the acoustic output apparatus into a predetermined space, sound that imitates the crowd cheer. This enables improvement of computer technology for audio generation and delivery by providing an integrated, machine-implemented pipeline that transforms natural-language prompt sentences into semantically controlled cheering audio, automatically optimized through digital signal processing and encoding for efficient, high-quality reproduction in diverse acoustic environments.

The term “system” refers to a combination of one or more information processing apparatuses and communication resources that cooperatively execute functions including reception of input data, processing of the input data, generation of output data, and transmission of the output data to external apparatuses.

The term “processor” refers to a hardware processing unit, such as a central processing unit or a graphics processing unit, and/or a combination of such units, configured by program instructions to execute arithmetic operations, logical operations, control operations, and data transfer operations.

The term “user terminal” refers to an information processing apparatus operated by a user, such as a mobile device, a portable computing device, or a stationary computing device, that is capable of transmitting input information to a server and receiving output information from the server via a communication path.

The term “communication path” refers to a logical or physical connection, including wired and wireless networks, that enables transmission and reception of information between the system and external apparatuses, such as user terminals or servers.

The term “request information” refers to structured data transmitted from a user terminal to the system, the structured data including at least a prompt sentence and associated condition information used for controlling generation of audio data.

The term “prompt sentence” refers to a sequence of characters or natural language text input by a user and interpreted by the system as an instruction specifying content, characteristics, or conditions of audio data to be generated.

The term “condition information” refers to data associated with a prompt sentence that indicates parameters for controlling audio generation, such as event type, duration, temporal pattern, emotional intensity, or audience reaction type.

The term “character information” refers to data representing symbols, letters, numerals, or other textual elements encoded in a character set and used to express a prompt sentence or other textual content.

The term “natural language processing” refers to a set of computational techniques applied to human language text, including tokenization, parsing, semantic analysis, and conversion of text into numerical representations suitable for machine processing.

The term “token sequence” refers to an ordered list of discrete units obtained from a prompt sentence by a tokenization process, each unit representing a word, subword, symbol, or other linguistic element.

The term “numerical representation” refers to data in a numeric form, such as token identifiers or vector embeddings, that encodes semantic or syntactic information of a prompt sentence for use by a machine learning model.

The term “generation input data” refers to data, including a token sequence and numerical representation derived from a prompt sentence and condition information, that is supplied to a generative model as an input for producing output data.

The term “generative artificial intelligence model” refers to a machine learning model, such as a neural network trained on large quantities of data, that is configured to generate output data, including audio signals, conditioned on input data such as a prompt sentence and associated parameters.

The term “information processing apparatus” refers to a hardware platform comprising at least one processor, a memory, and optionally an accelerator, configured to execute software components that implement the functions of the system.

The term “audio signal” refers to a time-varying signal representing sound, including a digital representation of acoustic waveform data suitable for storage, processing, or conversion to audible sound.

The term “acoustic waveform data” refers to numerical data representing sampled values of a time-domain waveform corresponding to physical sound pressure variations.

The term “digital audio data” refers to audio information represented in a digital format, such as pulse code modulation samples or encoded audio frames, that can be processed or stored by an information processing apparatus.

The term “signal processing algorithm” refers to a computational procedure that operates on audio data to analyze or modify properties of the data in the time domain, frequency domain, or other transform domain.

The term “frequency characteristics” refers to spectral properties of audio data, including distribution of energy across frequency components and relationships between different frequency bands.

The term “sound pressure level” refers to a quantitative measure of the magnitude of an audio signal, often expressed in decibels, representing the perceived loudness of sound.

The term “dynamic range” refers to a difference between a minimum amplitude level and a maximum amplitude level of an audio signal and indicates the range of loudness variation in the signal.

The term “noise components” refers to unwanted or non-ideal portions of an audio signal, including background noise, artifacts, or random fluctuations that do not correspond to desired sound content.

The term “filtering processing” refers to a signal processing operation that modifies audio data by attenuating or emphasizing certain frequency components, such as through low-pass, high-pass, band-pass, or band-stop filters.

The term “dynamic range compression processing” refers to a signal processing operation that reduces variation between higher and lower amplitude levels of an audio signal to control loudness and prevent clipping.

The term “equalization processing” refers to a signal processing operation that adjusts gain in specific frequency ranges to shape the tonal balance of an audio signal.

The term “noise reduction processing” refers to a signal processing operation that suppresses or removes noise components from an audio signal while preserving desired sound content as much as possible.

The term “volume normalization processing” refers to a signal processing operation that adjusts the overall gain of an audio signal to achieve a target loudness level or to match loudness across multiple audio signals.

The term “processed audio data” refers to audio data that has been modified through one or more signal processing operations to improve or correct acoustic quality relative to generated raw audio data.

The term “predetermined encoding scheme” refers to a predefined method for encoding digital audio data into a compressed or otherwise formatted representation, such as a particular audio codec or file format.

The term “storage format” refers to a digital file structure or container format used to store audio data on a recording medium, including information such as headers, metadata, and encoded audio frames.

The term “response information” refers to structured data transmitted from the system to a user terminal, the structured data including at least processed audio data and attribute information describing properties of the processed audio data.

The term “attribute information” refers to metadata associated with processed audio data, such as file format, sampling rate, bit rate, duration, codec type, or other descriptive parameters.

The term “acoustic output apparatus” refers to a device or combination of devices, such as a loudspeaker, amplifier, or audio reproduction system, that converts electrical or digital audio signals into audible sound.

The term “predetermined space” refers to a physical environment, such as an event venue, hall, or public area, in which sound radiated from an acoustic output apparatus is intended to be perceived by listeners.

The term “crowd cheer” refers to a collective vocal and non-vocal sound produced by a group of people, such as shouting, clapping, and whistling, and, in the context of the system, also refers to synthetic audio that imitates such sound.

The term “event type information” refers to data indicating a category or kind of event, such as a sports match, a concert, or a ceremony, used for controlling characteristics of generated cheering audio.

The term “temporal transition information” refers to data indicating how audio characteristics, such as intensity or density of cheering, should change over time within a generated audio sequence.

The term “emotional intensity information” refers to data representing a level or degree of emotional expression to be reflected in generated cheering audio, such as calm, moderate, or highly excited.

The term “audience reaction type information” refers to data indicating a kind of crowd response, such as applause, sustained cheering, rising cheer, booing, or mixed reactions, to be expressed in generated audio.

The term “semantic analysis” refers to a natural language processing operation that extracts meaning-related information from a prompt sentence, including event context, intent, and qualitative attributes, for use as control parameters in audio generation.

The term “control parameter” refers to a value or set of values provided to a generative artificial intelligence model or signal processing algorithm to influence the manner in which output data, such as cheering audio, is produced or modified.

The term “acoustic field conditions” refers to characteristics of an environment in which audio is reproduced, including room size, reverberation properties, typical listening distance, and background noise levels.

The term “acoustic characteristic information” refers to data describing properties of a reproduction space or sound system, such as frequency response, reverberation time, and maximum sound pressure level, used to optimize processed audio data for playback.

The term “public space” refers to an area accessible to a plurality of people, such as a stadium, arena, auditorium, or outdoor event location, where audio is reproduced for an audience.

The term “presence” refers to a subjective and objective quality of reproduced sound that contributes to a sense of realism and immersion for listeners in a given acoustic environment.

In one embodiment, the invention is implemented as a networked audio generation and playback system including a server and one or more terminals operated by users in event venues. The server includes at least one processor, a main memory, a non-volatile storage device, and a network interface. The processor may be a general-purpose central processing unit and/or a graphics processing unit. For example, the server uses an x86-compatible CPU and a GPU that supports parallel computation for neural network inference. The server executes software components including an operating system, a web application framework, a natural language processing library, a generative AI model framework, and an audio signal processing library. Examples of such components include a general-purpose operating system, a web server, an application framework, a machine learning framework such as a tensor-based deep learning framework, and an audio processing library such as a digital signal processing toolkit.

The terminal includes a processor, a memory, a display, an input interface, a network interface, and an audio output interface. The terminal may be a smartphone, a tablet, a personal computer, or a dedicated event control device. The terminal executes a user interface program that enables a user to input a prompt sentence as free text. The terminal converts the user's input into character data and structures it together with condition information, such as requested duration or intensity level, and then transmits this structured request information to the server via a communication network.

The user operates the terminal to input a prompt sentence that describes desired cheering audio. Example prompt sentences include “Generate a loud cheer at the end of the match,” “Generate a gradually increasing cheer as the home team scores a goal,” and “Generate continuous crowd murmur with occasional whistles.” The user optionally selects additional parameters on the terminal user interface, such as event type (for example, “soccer match” or “award ceremony”), desired length of the cheering sound in seconds, and target emotional intensity. The user confirms the input via a graphical user interface element, and the terminal encapsulates the prompt sentence and selected parameters into request information and sends it to the server.

The server receives the request information through the network interface and passes it to an application layer module. The server parses the received data structure and extracts the prompt sentence and associated condition information. The server stores this information in a defined internal data structure that includes fields for a token sequence, numerical embeddings, event type tags, temporal pattern tags, emotional intensity values, and audience reaction type codes. The server then performs natural language preprocessing on the prompt sentence using a text processing library. This preprocessing includes language normalization, tokenization into subword units, and mapping of tokens to numerical identifiers based on a predefined vocabulary associated with the generative AI model.

The server converts the token identifiers into numerical vector embeddings using an embedding matrix. In one embodiment, the server uses a transformer-based encoder to convert the sequence of token embeddings into a sequence of context-aware hidden representations. The generative AI model is configured as a two-stage architecture: a text encoder and an audio decoder. The text encoder is implemented as a stack of multi-head self-attention layers with feed-forward sub-layers and layer normalization. The audio decoder is implemented as a neural network that may include either an autoregressive waveform generator, a spectrogram generator followed by a vocoder, or a diffusion-based audio generation module. The server stores trained parameters of these networks in the non-volatile storage and loads the parameters into memory when the model is initialized.

The server supplies the token sequence embeddings and condition information to the generative AI model as generation input data. The condition information is converted into control vectors: for example, event type codes are embedded into vectors that bias the model toward certain crowd patterns, temporal pattern parameters specify envelope profiles for cheer intensity over time, emotional intensity values adjust global gain and density of simulated crowd voices, and audience reaction type codes select patterns such as applause, whistles, or mixed reactions. The model internally concatenates or injects these control vectors into the transformer layers through techniques such as conditional layer normalization or cross-attention to control the generation process.

The server executes the generative AI model on the GPU. During inference, the audio decoder generates a time-domain waveform or an intermediate time-frequency representation. In one variant, the server generates a mel-spectrogram that encodes time on one axis and frequency bands on the other axis, and then passes the mel-spectrogram to a neural vocoder that synthesizes waveform samples. The server uses efficient tensor operations to compute multiple layers of the network in parallel, improving throughput compared to conventional sequential audio editing workflows. The server selects a sampling rate, such as 44.1 kHz or 48 kHz, and produces a stream of floating-point PCM samples that represent the synthetic cheering sound.

The server converts the floating-point samples into a standard digital audio format, such as 16-bit linear PCM, and then passes the buffer to an audio processing module. This module implements digital signal processing operations, including analysis and modification of frequency characteristics, sound pressure level, dynamic range, and noise components. The server performs a fast Fourier transform on overlapping frames of the waveform to obtain spectral data. The server analyzes this spectral data to identify frequency bands that are either under-represented or over-emphasized relative to target venue profiles stored in a configuration database.

The server applies equalization filters tailored to the spectral profile of large event venues. For example, the server may raise energy in a mid-frequency band that enhances perceived crowd presence and reduce excessive low-frequency energy that could cause unwanted resonance in large halls. The server applies a dynamic range compression algorithm with specified attack and release times and a threshold that is calibrated to prevent clipping in the downstream amplification system. The server performs noise reduction by attenuating spectral components that are inconsistent with typical crowd spectra, based on a noise profile derived from training data or predefined templates.

The server normalizes the overall loudness of the processed waveform to a target level. In one embodiment, the server measures integrated loudness using a standardized algorithm and adjusts the gain so that the cheering audio matches the operational range of standard public address systems. The server then encodes the processed audio using an audio encoder that implements a predetermined encoding scheme, such as a compressed audio codec or an uncompressed container format. The server attaches metadata including duration, sampling rate, encoding format, and intensity level to the processed audio, forming response information.

The server transmits the response information, including the processed audio data, back to the terminal via the communication network. The terminal receives the processed audio, decodes it if it is in a compressed format, and stores it in a buffer or a local file. The terminal then outputs the audio to an acoustic output apparatus such as an amplifier and loudspeaker array installed in the event venue. The terminal uses operating system audio APIs to configure the sample rate, buffer size, and routing to the correct physical output device, such as a wired line-out port or a digital audio interface connected to the venue mixing console. The user perceives the resulting cheering sound, which exhibits a temporal profile and emotional intensity corresponding to the originally input prompt sentence.

This embodiment yields technical effects beyond mere automation of human selection of pre-recorded sounds. The server improves processing speed and computational efficiency by integrating natural language understanding, generative audio synthesis, and venue-specific signal processing within a single optimized pipeline. The transformer-based encoder and decoder architecture allows the server to generate long, structured cheering sequences in a single pass, reducing the need for manual editing or repeated regeneration. The embedding of condition information as control parameters enables the server to reuse one trained model for multiple event types and acoustic conditions, thereby reducing model size and training redundancy.

The server improves accuracy of semantic-to-audio mapping by explicitly extracting and encoding event type information, temporal transition information, emotional intensity information, and audience reaction type information from the prompt sentence. This structured semantic information is used not only by the generative AI model but also by the downstream signal processing module. For example, if the semantic analysis indicates a “gradually increasing cheer,” the server shapes the amplitude envelope and spectral emphasis to follow a rising pattern, which reduces mismatch between the model's raw output and the desired acoustic behavior. This coordinated use of semantic features across model inference and signal processing is not a simple textual classification task; it constitutes a technical optimization of the audio generation pipeline that improves perceptual realism and reduces artifacts.

The server applies specific learning methods when training the generative AI model. In one configuration, the server trains the model on a dataset of paired text descriptions and crowd audio recordings. The server splits the data into mini-batches and computes a loss function such as a combination of waveform reconstruction error, spectrogram loss, and adversarial loss to enforce realism. The server updates model parameters by gradient-based optimization. The server may apply data augmentation techniques such as time-stretching or adding controlled noise to improve robustness. By training the model to map prompt sentences and structured condition information to realistic cheering audio, the server creates a model that can generalize to new prompt sentences with high fidelity and reduced error rates.

The server improves communication efficiency between the terminal and the server by structuring request and response information. Because the prompt sentence and condition information are compact textual representations, the server avoids transmitting raw audio from the terminal to the server. Conversely, by performing heavy computation and audio processing on the server side, the system reduces computational load on terminals that may have limited processing power. The server can further optimize bandwidth by selecting encoding schemes based on network conditions, thereby lowering communication overhead while maintaining sufficient audio quality for venue playback.

In another embodiment, the server maintains a library of venue-specific acoustic profiles. The server associates each profile with parameters such as reverberation time, typical background noise level, and maximum safe sound pressure level. When the user specifies a particular venue type, or when the terminal reports a venue identifier, the server selects the corresponding profile and adjusts equalization, compression, and normalization parameters accordingly. This targeted optimization of processed audio improves clarity and uniformity of cheering sound across different venues, illustrating a direct control of physical audio equipment and space, rather than an abstract data manipulation.

In yet another embodiment, the terminal is configured to provide feedback to the server about measured sound levels in the venue using a built-in microphone. The server analyzes this feedback to adapt subsequent generated cheering sounds, adjusting intensity or spectral balance. This closed-loop adaptation further improves technical performance of the system, allowing it to converge on optimal settings for a given environment faster than manual tuning methods.

The user can employ the system in various usage scenarios. For instance, the user may input “Generate a short but intense cheer for a successful three-point shot” during a sports game. The terminal sends this prompt sentence, and the server generates a corresponding cheering sound that peaks quickly and decays rapidly, tuned for the indoor arena profile. In a different scenario, the user may input “Generate moderate applause suitable for an award announcement,” and the server produces a more restrained, evenly distributed applause pattern, optimized for a conference hall acoustic profile. Through these examples, the system demonstrates the ability to adapt both semantic content and technical acoustic parameters.

The described embodiments can be modified in various ways without departing from the scope of the claims. For example, the generative AI model may utilize alternative architectures, such as recurrent neural networks or hybrid convolutional-transformer structures, as long as the model receives a token sequence and condition information and outputs audio signals. The audio processing module may incorporate additional algorithms, such as dynamic equalization or multiband compression. The communication protocol between the terminal and the server may be implemented using different transport layers, provided that request information and response information are structured and processed as described.

In all embodiments, the server, the terminal, and the user cooperate through concrete hardware and software operations to transform input prompt sentences into technically optimized cheering audio that controls real-world acoustic output devices. This integration of semantic analysis, generative AI modeling, and signal processing yields improvements in generation accuracy, processing speed, computational efficiency, and communication overhead, and thus constitutes an improvement in computer technology rather than a mere automation of human selection behavior.

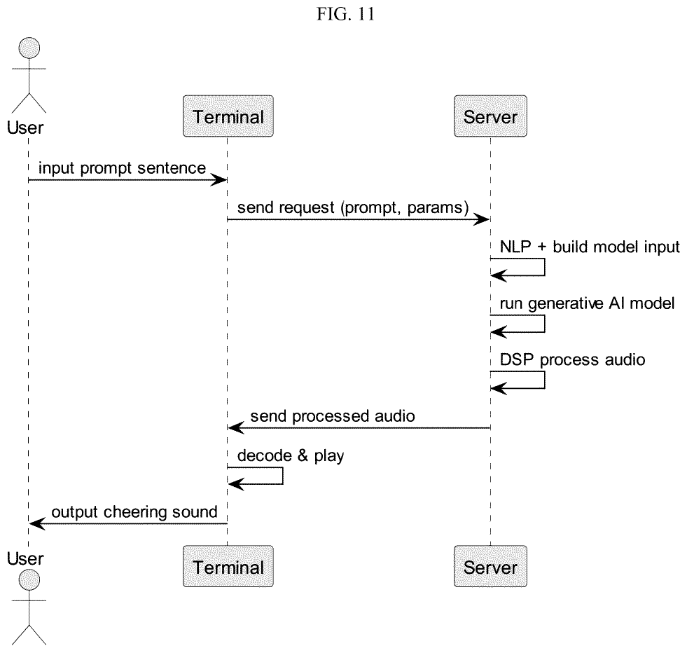

The following describes the processing flow using FIG. 11.

### Step 1

The user operates the terminal to launch an application and open a text input field for a prompt sentence. The input of this step is the user's intention to generate cheering audio, which the user expresses as natural language. The user types a prompt sentence such as “Generate a loud cheer at the end of the match” or “Generate a gradually increasing cheer as the home team scores a goal,” and confirms the input via a button on the display. The output of this step is character string data representing the prompt sentence held in the terminal's memory.

### Step 2

The terminal acquires the prompt sentence from the input component of the operating system and stores it as a Unicode string. The input of this step is the character data entered by the user. The terminal validates the content (for example, checking length and allowed characters) and associates it with condition parameters selected on the user interface, such as event type, desired duration, and emotional intensity. The terminal structures these elements into a request object containing fields for the prompt sentence and condition information. The output of this step is structured request information stored in the terminal's working memory.

### Step 3

The terminal transmits the request information to the server via a network interface using a communication protocol. The input of this step is the structured request object generated in Step 2. The terminal serializes the request information into a data format and encapsulates it in a network message with appropriate headers, then sends the message through the network stack to the server's address. The output of this step is a network packet stream carrying the prompt sentence and condition information to the server.

### Step 4

The server receives the network message through a network interface and parses the request information. The input of this step is the packet stream containing the serialized request. The server reconstructs the structured request object by performing deserialization and integrity checks, then extracts the prompt sentence string and associated condition fields (for example, event type, temporal pattern, emotional intensity, and audience reaction type). The output of this step is an internal data structure on the server containing the prompt sentence and condition information in a machine-usable form.

### Step 5:

The server performs natural language preprocessing on the prompt sentence to obtain a token sequence and initial numerical representations. The input of this step is the prompt sentence text from the internal data structure. The server normalizes the text (for example, lowercasing and trimming whitespace), tokenizes it into subword or word units using a tokenizer, and maps each token to a token identifier according to a predefined vocabulary. The server then converts the token identifiers into embedding vectors using an embedding matrix stored in memory. The output of this step is a sequence of embedding vectors representing the prompt sentence and a corresponding sequence of token identifiers.

### Step 6

The server converts the condition information into control parameters suitable for the generative AI model. The input of this step is the event type, temporal transition information, emotional intensity, and audience reaction type extracted in Step 4. The server maps categorical values (for example, “soccer match” or “applause”) to numeric codes and then to control embeddings, and scales continuous values (for example, target intensity from 0 to 1) into normalized numeric ranges. The server aggregates these control embeddings into a control vector sequence or a set of conditioning tensors aligned with the token embeddings. The output of this step is a set of control parameters expressed as numerical data structures ready to be supplied to the generative AI model.

### Step 7

The server constructs generation input data for the generative AI model by combining the token embeddings and control parameters. The input of this step is the sequence of prompt embeddings from Step 5 and the conditioning tensors from Step 6. The server concatenates, adds, or injects the control parameters into the embedding sequence according to the model's architecture (for example, by adding control vectors to layer normalization inputs or by providing them as keys and values for cross-attention). The server then assembles these elements into a tensor with the dimensions expected by the model (for example, batch size, sequence length, and embedding dimension). The output of this step is a generation input tensor loaded into main memory or GPU memory.

### Step 8

The server executes the generative AI model to generate an audio representation corresponding to the prompt sentence and control parameters. The input of this step is the generation input tensor from Step 7. The server runs the text encoder portion of the model to transform the input embeddings into context-aware hidden states using operations such as multi-head attention, matrix multiplications, and non-linear activations. The server then inputs these hidden states and control parameters into an audio decoder, which computes either a time-frequency representation (for example, a mel-spectrogram) or a sequence of waveform samples by iterative or parallel generation steps. The output of this step is an intermediate audio representation, such as a mel-spectrogram sequence or a raw floating-point waveform stored in memory.

### Step 9

The server converts the intermediate audio representation into a time-domain waveform if necessary and standardizes the sample format. The input of this step is the mel-spectrogram or other intermediate representation from Step 8. When a spectrogram is used, the server feeds it into a neural vocoder module, which applies upsampling, convolutional filters, and non-linear activations to reconstruct time-domain waveform samples. The server then ensures that the waveform has a target sampling rate and amplitude range, converting floating-point samples to a standard format such as 16-bit PCM. The output of this step is a continuous digital audio waveform representing the generated cheering sound.

### Step 10

The server analyzes the raw digital audio waveform to derive frequency and amplitude characteristics. The input of this step is the generated waveform from Step 9. The server segments the waveform into overlapping frames and applies a window function, then performs a fast Fourier transform on each frame to obtain frequency domain data. The server calculates metrics such as average spectral energy per band, root-mean-square level, peak level, and dynamic range. The output of this step is a set of spectral and temporal analysis results stored as numerical arrays associated with the waveform.

### Step 11

The server applies signal processing operations to adjust the audio according to venue and quality requirements. The input of this step is the raw waveform and the analysis results from Step 10, as well as, optionally, venue profile data. The server designs or selects filter coefficients for equalization to emphasize or attenuate specified frequency bands, computes compressor parameters (threshold, ratio, attack, and release) for dynamic range compression, and determines gain factors for normalization. The server then processes the waveform frame by frame, applying filtering, compression, noise reduction (for example, by attenuating spectral components that deviate from expected crowd spectra), and overall gain adjustment. The output of this step is processed audio data with corrected acoustic quality.

### Step 12

The server encodes the processed audio data into a specified delivery format and attaches attribute information. The input of this step is the processed waveform from Step 11. The server selects an encoding scheme based on configuration or terminal capability (for example, uncompressed or compressed coding) and runs an encoder to convert the waveform into encoded frames or a container file. The server also generates attribute information such as sampling rate, bit rate, duration, and format identifier, and packages these together with the encoded data into response information. The output of this step is a structured response object containing the encoded processed audio data and its attributes.

### Step 13

The server transmits the response information to the terminal over the network. The input of this step is the structured response object from Step 12. The server serializes the response, embeds the encoded audio and attribute information into a response message, and sends the message through a communication interface to the terminal's network address. The output of this step is a stream of network packets carrying the processed audio back to the terminal.

### Step 14

The terminal receives the response message and reconstructs the processed audio and attribute information. The input of this step is the packet stream containing the serialized response from the server. The terminal reassembles the packets, deserializes the response object, and separates encoded audio data from attribute metadata. The terminal may store the encoded audio temporarily in local storage or keep it in a buffer. The output of this step is an accessible representation of the encoded processed audio and associated attributes on the terminal.

### Step 15

The terminal decodes the processed audio and prepares it for output to an acoustic output apparatus. The input of this step is the encoded processed audio data and its attributes from Step 14. The terminal configures a decoder according to the encoding scheme indicated by the attributes and converts the encoded frames back into a sequence of PCM samples. The terminal then configures audio output parameters such as output device, sampling rate, and volume level using the operating system audio interface. The output of this step is a continuous PCM audio stream routed to the designated output device interface.

### Step 16

The terminal outputs the PCM audio stream to the acoustic output apparatus installed in the event venue, and the user perceives the generated cheering sound. The input of this step is the PCM stream produced in Step 15. The terminal transmits the samples through a hardware interface, such as an analog line-out port or a digital audio interface, to an amplifier and loudspeaker system. The amplifier drives the loudspeakers to radiate sound pressure waves into the venue space. The output of this step is an audible cheering sound in the physical environment, whose temporal evolution and intensity correspond to the original prompt sentence and control conditions specified by the user.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional content distribution systems generally handle audience reactions and audio effects as separate, manually coordinated processes. In a typical implementation, text comments and reaction inputs from viewers are merely displayed on a user interface, while crowd cheers and other sound effects are pre-produced and triggered by human operators or simple rule-based schedulers. As a result, such systems are unable to transform large-scale, real-time audience feedback into dynamically generated crowd audio that is temporally aligned with the content and acoustically optimized for heterogeneous playback environments.

From a computer-technology standpoint, existing systems exhibit several limitations. First, they do not exploit natural language processing and generative information processing models to convert free-form, real-time reaction data into structured control parameters for audio generation. The raw reaction data (for example, unstructured comments) remains underutilized, and server-side processing pipelines are not configured to compute machine-interpretable indices, such as a crowd excitement level, that can drive low-latency media signal processing. Second, current server architectures generally lack an integrated, automated pipeline that: (i) ingests and aggregates reaction information; (ii) computes an aggregate emotion index over sliding time windows; (iii) converts the aggregate index into a prompt sentence; (iv) invokes a generative model to produce high-level descriptions of cheer audio; and (v) maps those descriptions to concrete audio-signal parameters used to synthesize and mix crowd sound sources in real time. Consequently, the burden remains on human operators or static configuration to design and insert crowd sounds, which limits scalability and responsiveness and prevents efficient utilization of processing resources.

Third, media servers and associated processing modules in existing systems are not configured to intelligently embed synthesized cheer audio into ongoing or recorded audio-video signals while adapting to diverse acoustic conditions. Mixing is typically conducted with fixed gain and equalization settings, without dynamically adjusting volume, reverberation, frequency characteristics, and spatial arrangement of the crowd audio based on estimated venue acoustics or remote viewing environment. This lack of adaptive, algorithmic mixing leads to suboptimal audibility and a reduced sense of presence, especially when the generated cheer audio must coexist with commentary, background music, and environmental sounds across various device types and output channels.

In addition, known systems do not provide a systematic, feedback-driven mechanism in which real-time audience reactions are continuously analyzed and translated into machine-readable control signals that update prompt sentences for generative models. Without such a mechanism, the system cannot maintain an appropriate frequency, intensity, and style of generated cheers in response to live audience dynamics, leading either to underwhelming or excessively intrusive audio effects. Overall, server-side processing architectures are not designed to tightly integrate reaction analysis, generative modeling, and audio signal synthesis into a coherent computational workflow that improves how a computer generates, controls, and delivers media content.

Accordingly, there is a need for a computer-implemented system and method that improves server-side processing of audience reaction information by transforming unstructured reaction streams into structured indices, automatically generating prompt sentences for a generative information processing model, converting generative outputs into audio synthesis parameters, and integrating synthesized crowd cheers into audio-video signals with adaptive acoustic optimization. Such a system should enhance the technical performance of the media processing pipeline itself, including improved scalability, reduced manual intervention, better utilization of computational resources, and more consistent audio quality across heterogeneous devices and environments.

The specific processing by the specific processing unit 290 of the data processing device 12 in Application Example 1 is realized by the following means.

The present invention provides a server comprising a processor configured to acquire reaction information transmitted from viewers via a communication network and store the reaction information in time series as accumulated reaction information; analyze the accumulated reaction information by using natural language processing to calculate, for each piece of the reaction information, an emotion index and to generate, by aggregating the emotion indexes within a predetermined time period, an aggregate index indicating a crowd excitement level; generate, on the basis of the aggregate index, a prompt sentence indicating a scale and a temporal transition of a crowd cheer, input the prompt sentence into a generative information processing model, and obtain, from the generative information processing model, generation result information describing characteristics of an audio signal that imitates a crowd cheer; select, on the basis of the generation result information, a plurality of pre-recorded crowd audio sources, set, as parameters according to the characteristics, at least a time length, a volume level, a frequency characteristic, and a mixing ratio, and perform signal processing to mix the plurality of crowd audio sources so as to generate cheer audio data; associate the cheer audio data with a predetermined time position of at least one of a distribution target audio-video signal and a recorded audio-video signal, and integrate the cheer audio data into the audio-video signal so as to generate distribution media data for a plurality of terminals; and transmit the distribution media data to the terminals and control playback at the terminals such that the cheer audio data is reproduced to provide an immersive viewing experience to users. This enables the computer-implemented media processing pipeline to automatically transform large-scale, unstructured audience reaction streams into structured control parameters for generative modeling and audio synthesis, to generate and embed crowd cheer audio that is both temporally synchronized with content and acoustically optimized for diverse playback environments, and to improve the technical operation of the server by reducing manual intervention, enhancing responsiveness, and maintaining consistent audio quality and presence across heterogeneous devices.

The term “reaction information” refers to data indicating responses of viewers to content, including but not limited to text comments, symbolic reactions, stamps, and other interaction signals transmitted from terminals via a communication network.

The term “communication network” refers to any wired or wireless data transmission infrastructure, including local area networks, wide area networks, and public data networks, that enables terminals to exchange information with a server.

The term “time series” refers to an ordered sequence of data elements each associated with temporal information, such as timestamps, enabling processing based on temporal order or time windows.

The term “accumulated reaction information” refers to reaction information that has been collected and stored over time in association with temporal information so that the reaction information can be processed in chronological order or within defined time intervals.

The term “natural language processing” refers to computational techniques that analyze or transform human language input, including tokenization, parsing, classification, sentiment analysis, and other operations that convert unstructured text into structured or numerical representations.

The term “emotion index” refers to a numerical or categorical indicator computed from a piece of reaction information, representing an estimated emotional state, such as positivity, negativity, neutrality, or intensity of excitement.

The term “aggregate index” refers to a numerical or categorical indicator derived from a plurality of emotion indexes within a predetermined time period, representing an overall state such as a crowd excitement level or collective emotional tendency.

The term “crowd excitement level” refers to a value indicating a degree of enthusiasm or arousal of a group of viewers, calculated by aggregating emotion indexes derived from multiple pieces of reaction information.

The term “prompt sentence” refers to a sequence of natural language characters or tokens provided as input to a generative information processing model in order to specify or constrain the content, style, or properties of generated output.

The term “scale of a crowd cheer” refers to a magnitude indication of a cheer, such as the apparent number of people involved, perceived loudness, or crowd size category.

The term “temporal transition of a crowd cheer” refers to a pattern of change of a cheer over time, including rise time, decay time, sustained segments, and other temporal dynamics of the cheering sound.

The term “generative information processing model” refers to a computational model configured to generate information, such as text, parameters, or other data, in response to an input including a prompt sentence, using learned statistical or machine-learning based relationships.

The term “generation result information” refers to output data produced by the generative information processing model in response to a prompt sentence, describing characteristics or control information for an audio signal that imitates a crowd cheer.

The term “characteristics of an audio signal that imitates a crowd cheer” refers to descriptive or parametric attributes of an audio signal intended to resemble audience cheering, including intensity, duration, component types, timbre, and temporal behavior.

The term “pre-recorded crowd audio sources” refers to stored audio signals previously captured or synthesized that represent sounds of crowds, cheers, applause, or related audience noises and that can be selected and combined to form new cheer audio.

The term “time length” refers to a temporal duration parameter indicating how long a synthesized or processed audio segment, such as a cheer, extends in time.

The term “volume level” refers to a parameter indicating the amplitude or loudness of an audio signal, typically subject to gain control or normalization during signal processing.

The term “frequency characteristic” refers to a distribution or emphasis of frequency components of an audio signal, which may be adjusted by equalization, filtering, or similar processing.

The term “mixing ratio” refers to a set of parameters defining relative levels or weights applied when combining multiple audio signals or tracks into a single audio signal.

The term “signal processing” refers to computational operations applied to digital audio data, including but not limited to mixing, filtering, equalization, compression, reverberation, resampling, and normalization.

The term “cheer audio data” refers to digital audio data representing an artificial or synthesized cheer, produced by processing one or more pre-recorded crowd audio sources according to specified parameters.

The term “distribution target audio-video signal” refers to an audio-video signal that is currently being prepared or delivered for real-time or near-real-time distribution to terminals.

The term “recorded audio-video signal” refers to an audio-video signal that has been previously captured and stored, and that can be edited, processed, or redistributed at a later time.

The term “predetermined time position” refers to a specific point or interval on a time axis associated with an audio-video signal, selected for associating or inserting additional audio components such as cheer audio data.

The term “distribution media data” refers to encoded or formatted digital data comprising at least one audio-video signal, prepared for delivery over a communication network to one or more terminals in a stream or file form.

The term “terminal” refers to an information processing device, such as a mobile device, a stationary computing device, a wearable display device, or a multimedia receiver, that receives distribution media data and reproduces audio and/or video for a user.

The term “immersive viewing experience” refers to a viewing condition in which a user perceives an increased sense of presence, engagement, or realism as a result of coordinated audio-video presentation, including adaptive crowd cheer audio.

The term “cheer intensity category” refers to a classification level indicating a relative strength of a cheer, such as low, medium, or high intensity.

The term “cheer duration category” refers to a classification level indicating a relative temporal length of a cheer, such as short, medium, or long duration.

The term “cheer component category” refers to a classification level indicating types of sound elements included in a cheer, such as shouting, applause, whistles, or other crowd noises.

The term “parameter sequence” refers to an ordered set of parameters, such as numeric or symbolic values, that can be interpreted by an audio synthesis or mixing function to generate or modify an audio signal.

The term “audio synthesis function” refers to a computational function or module that generates or modifies audio data based on a set of input parameters and one or more audio sources.

The term “acoustic conditions” refers to environmental and system characteristics that affect audio perception, including room reverberation, background noise level, playback device properties, and spatial arrangement of speakers.

The term “reverberation characteristic” refers to a property of an audio signal related to reflections and decay in a physical or simulated space, often controlled by parameters such as decay time, pre-delay, and diffusion.

The term “spatial arrangement” refers to a configuration of audio signals in a spatial domain, such as stereo or multichannel positions, virtual source locations, or spatialization parameters that affect perceived direction and distance.

The term “audibility” refers to a degree to which an audio signal, such as cheer audio data, can be clearly perceived by a listener relative to other audio components.

The term “sense of presence” refers to a perceived degree of realism or being “in” an environment, influenced by audio and visual cues, including appropriately mixed crowd cheer audio.

The term “predetermined range” refers to a range of values or conditions specified in advance for one or more metrics, such as loudness or presence, within which an audio signal is to be controlled or maintained.

In one embodiment, a server, a plurality of terminals, and users cooperate to implement the invention.

The server is implemented on computing hardware such as a rack-mount server including a multi-core central processing unit, a graphics processing unit configured for parallel numerical computation, a volatile memory, a non-volatile storage device, and a network interface. The server executes system software such as an operating system and a runtime environment for a programming language such as Python. The server further executes application software modules including a web application framework, a natural language processing library, a numerical computation library, an audio signal processing library, and a generative AI model.

The terminal is implemented as an information processing device such as a smartphone, a tablet, a head-mounted display, or a smart television. The terminal includes a processor, a memory, a display device, an audio output device such as speakers or headphones, an input interface such as a touch screen, and a network interface. The terminal executes a client application or a web browser capable of requesting and decoding audio-video streams and of transmitting viewer reaction information to the server.

The user operates the terminal to watch audio-video content and to transmit reaction information such as text comments or symbolic reactions. The user perceives playback of synthesized cheer audio that the server embeds into a content stream and thus experiences an enhanced sense of presence.

The server manages a data storage unit that stores at least the following data structures: a reaction information table, a time-series buffer, an emotion index table, an aggregate index table, prompt sentence templates, generation result records, and audio asset metadata. The reaction information table associates a reaction identifier, a user identifier, an event identifier, a timestamp, and a reaction payload such as comment text or reaction type. The time-series buffer is realized as a ring buffer or queue in the memory, storing recent reaction identifiers ordered by timestamp. The emotion index table stores, for each reaction identifier, a numeric emotion score and a categorical label. The aggregate index table stores, for each time window, a crowd excitement level, which is derived from the emotion scores. The prompt sentence templates are textual patterns including parameters that are replaced according to the crowd excitement level and other context. The generation result records store structured parameters obtained from generation result information. The audio asset metadata describe attributes of pre-recorded crowd audio sources, including duration, frequency distribution, perceived intensity, and component type.

The server uses a natural language processing module to convert reaction information into emotion indexes. In one embodiment, the server uses a recurrent neural network-based or transformer-based sentiment classifier. The server tokenizes a comment into subword units, maps each token to an embedding vector, and inputs a sequence of embedding vectors to a neural network. The neural network may implement multiple encoder layers with self-attention mechanisms, each layer computing attention weights between tokens and producing a contextual representation. The server extracts a sentence-level representation by applying pooling or by taking the hidden state associated with a special classification token. The server feeds this representation into a fully connected layer followed by a softmax function to obtain probabilities for classes such as positive, neutral, and negative. The server derives an emotion index as a scalar value by computing a weighted sum of class probabilities or by reading the activation of a regression output node.

The server trains the sentiment classifier in advance using a training dataset containing text samples and labeled sentiments. During training, the server minimizes a loss function such as cross-entropy loss for classification or mean squared error for regression. The server updates neural network weights using an optimization algorithm such as stochastic gradient descent or an adaptive gradient method. The server optionally augments the training data by operations such as synonym replacement, noise injection, or back-translation to improve generalization. The server stores trained model parameters in the storage device and loads them into memory when executing the natural language processing module.

The server computes an aggregate index representing a crowd excitement level by aggregating emotion indexes over a predetermined sliding window. The server may use a fixed-length window such as several seconds and accumulate emotion indexes for all reactions in that interval. The server computes statistics such as an average emotion score, a variance, and a reaction density. The server maps the average emotion score and the reaction density to a crowd excitement level by a non-linear function or a lookup table. This mapping can include thresholds to classify the crowd excitement level into discrete categories such as low, medium, and high. By using a defined aggregation algorithm, the server reduces noise from individual reactions and stabilizes the control signal used for subsequent audio synthesis.

The server generates a prompt sentence for a generative AI model based on the aggregate index and optional contextual information. The server selects a prompt template that corresponds to the crowd excitement level and then fills in parameters such as intensity descriptors, duration descriptors, and component descriptors. For example, when the crowd excitement level indicates a high value, the server may generate a prompt sentence such as:
“Please generate the sound of the audience cheering loudly.”

When the crowd excitement level indicates a gradually increasing excitement, the server may generate a prompt sentence such as:
“Please express the scene where the audience gradually builds excitement and finally erupts in loud cheers through sound.”

In another example, when a decisive scene occurs, the server may generate a prompt sentence such as:
“Describe in detail the loud cheers and applause immediately after the decisive goal was scored in the sports championship game.”

The server uses the generative AI model as a generative information processing model that receives the prompt sentence and outputs generation result information describing characteristics of a crowd cheer. In one embodiment, the generative AI model is implemented as a transformer-based language model with multiple layers of self-attention, trained on a large corpus of text including descriptions of soundscapes and crowd behavior. The server represents the prompt sentence as a sequence of token identifiers by applying a tokenizer. The server feeds the token sequence into the generative AI model, which computes contextualized token representations through repeated application of attention and feed-forward layers, and then predicts subsequent tokens forming a descriptive text sequence.

The server configures the generative AI model with generation parameters such as a maximum token length, a sampling temperature, and a top-k or top-p sampling threshold. By controlling these parameters, the server influences the diversity and determinism of the generated description. The server receives the generated text and parses it in order to extract generation result information. For example, the server searches the generated text for numeric expressions corresponding to duration, intensity levels expressed by linguistic cues such as “small,” “huge,” or “deafening,” and mentions of sound components such as “applause,” “whistles,” or “chants.” The server uses rule-based extraction, regular expressions, or an auxiliary classifier to map the descriptive text to structured parameters.

The server converts the structured parameters into a parameter sequence interpretable by an audio synthesis function. The parameter sequence may include a target duration, an overall loudness target, individual gain values for different components, equalization curves, reverberation parameters, and spatial placement information. In one embodiment, the server represents the parameter sequence as a structured object in memory, with fields specifying each parameter and corresponding numeric values. This structured representation enables deterministic and reproducible audio synthesis based on the generative output.

The server uses an audio synthesis function implemented by an audio signal processing library to generate cheer audio data from pre-recorded crowd audio sources. The server stores multiple pre-recorded audio assets for cheers, applause, whistles, and background crowd noise in the storage device. Each asset has associated metadata describing its intensity, spectral content, and typical use case. The server selects a subset of these assets based on the parameter sequence. For instance, if the generative AI model indicates the presence of whistles and loud applause, the server selects whistle tracks and applause tracks matching the requested intensity.

The server loads the selected audio assets into memory and resamples them to a common sampling rate and bit depth. The server applies time-stretching or trimming operations to match the target duration. The server then applies equalization filters to adjust the frequency characteristics based on the parameter sequence, boosting or attenuating specific bands to achieve the perceived timbre indicated by the description. The server adjusts the gain of each component to satisfy the specified mixing ratio and overall loudness target. The server applies dynamic range compression to control peaks and enhance perceived loudness while preserving headroom for other audio components.

The server positions the components in a stereo or multi-channel field by applying panning and, if applicable, spatial audio rendering techniques. The server then mixes the components into a single cheer audio track by summing the processed signals and normalizing the result to a desired loudness level. The server encodes the resulting audio signal into a suitable format such as an advanced audio codec and stores the cheer audio data in the storage device. By automating this audio synthesis pipeline, the server can generate a wide variety of cheer sounds in real time, without requiring human sound engineers to perform manual editing or mixing.

The server associates the cheer audio data with a predetermined time position of a distribution target audio-video signal or a recorded audio-video signal. The server manages a timeline for each content stream and aligns the cheer audio with events such as scoring moments, highlight plays, or user-defined markers. The server generates distribution media data by combining the original content audio with the synthesized cheer audio. The server can embed the cheer audio as an additional audio track or mix it into an existing track, depending on the implementation. The server uses a media processing tool to multiplex the modified audio with corresponding video frames into streaming segments or container files.

The server further adjusts the cheer audio data according to estimated acoustic conditions. The server may maintain configuration profiles for different environments, such as small rooms, large halls, or mobile listening scenarios. Based on these profiles and on information from the terminal regarding device type or output capability, the server modifies parameters such as reverberation time, equalization, and spatial arrangement. By tailoring the cheer audio to the playback environment, the server improves audibility and the sense of presence. The server then makes the distribution media data available through a streaming protocol such as an adaptive bitrate streaming format.

The terminal requests distribution media data from the server using the network interface. The terminal receives streaming segments containing both the base content and the embedded cheer audio data. The terminal decodes the audio and video components using built-in codecs and renders them in synchronization. The terminal outputs the audio through speakers or headphones. The terminal can report playback conditions or user preferences back to the server, allowing the server to adjust future cheer generation to avoid excessive loudness or to respect user settings.

The user watches the audio-video content on the terminal and experiences cheer audio that responds to the collective reactions of viewers. The user continues to input reactions such as text comments. Because the server continuously analyzes these reactions and updates the aggregate index, the prompt sentences and resulting cheer audio evolve over time, providing a dynamic and context-sensitive soundscape.

From a technical perspective, the server improves computer technology by organizing unstructured reaction data into specific data structures optimized for real-time processing, by employing a defined algorithm that transforms emotion indexes into a crowd excitement level and then into prompt sentences, and by mapping generative model outputs to deterministic parameter sequences for audio synthesis. These processing steps reduce the need to transfer high-bandwidth raw audio or video back to centralized mixing operators, thereby reducing communication load. The use of sliding windows and aggregate indexes reduces computational overhead by limiting the volume of data that must be processed for each update. Compared to manual sound design, the server can respond at machine timescales to changes in viewer reactions, enabling more timely and consistent updates to the audio stream.

The server also achieves higher precision in controlling cheer audio characteristics by decoupling semantic description from signal generation. The generative AI model outputs high-level, human-interpretable descriptions, which the server subsequently interprets according to defined rules. This separation allows the server to impose strict constraints on signal processing parameters and avoid unpredictable audio artifacts. The server can apply non-conventional rules, such as mapping specific linguistic intensity cues to non-linear gain curves or using reaction density functions to set reverberation tails, which would be difficult for human operators to do consistently in real time.

The use of neural network models with trained weights, loss functions, and optimization algorithms provides improved accuracy and robustness in emotion recognition compared to rule-based systems. By using data augmentation and large training corpora, the server achieves better generalization to diverse comment styles and languages, which enhances the reliability of the crowd excitement level estimation. The result is a reduction in misclassification of audience mood and a corresponding reduction in inappropriate or mistimed cheer audio. Furthermore, by performing emotion analysis and audio synthesis on the server with efficient model architectures and optimized numerical computation libraries, the system reduces processing latency and resource consumption, improving throughput and scalability.

In alternative embodiments, the server may employ different machine learning architectures for the natural language processing module, such as convolutional neural networks or hybrid models, or may use different generative AI models for generating descriptive text, parameter vectors, or even raw audio waveforms. The server may also store and manage alternative sets of audio assets, such as multichannel recordings for surround systems or binaural recordings for headphone playback. The terminal may be implemented as a head-mounted display that supports spatial audio rendering, in which case the server can provide object-based audio metadata for more precise spatial placement of crowd sounds.

In another embodiment, the server may perform part of the audio synthesis on an edge device while maintaining central control of the aggregate index and prompt sentence generation. In yet another embodiment, the server may support multiple content channels simultaneously, each with its own reaction information, aggregate index, and cheer audio generation, thereby demonstrating scalability. These variations all remain within the scope of the invention because the core concept of generating and using a prompt sentence for a generative AI model based on structured reaction analysis, and of converting the resulting information into concrete audio synthesis parameters for embedding into an audio-video signal, does not change.

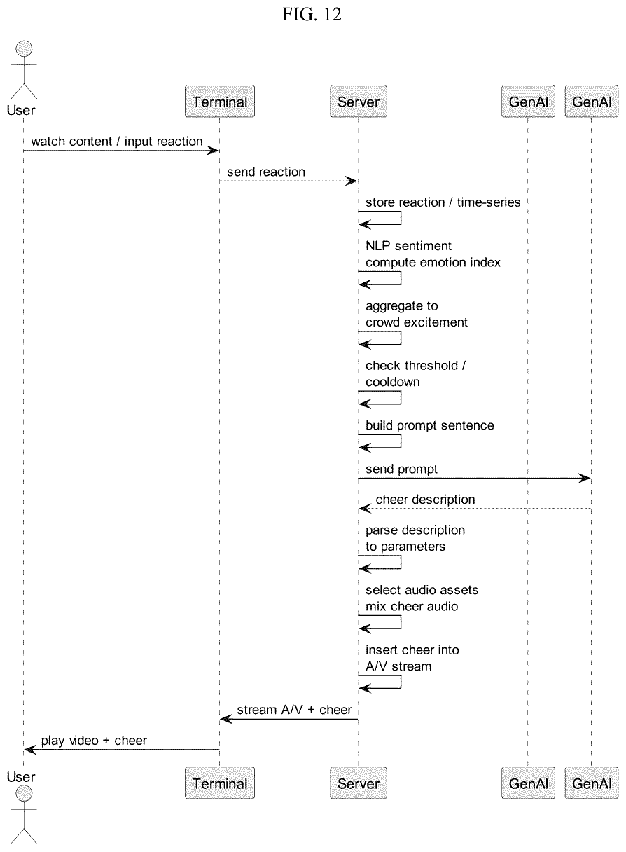

The following describes the processing flow using FIG. 12.

### Step 1

The user operates the terminal to watch an audio-video stream and to input reaction information. The user views content on the display of the terminal and enters a text comment such as “Wow!” or taps a reaction button such as a “cheer” icon. The input is a user action on the graphical user interface of the terminal, and the output is reaction information including at least a comment string or reaction type, together with a local timestamp. The terminal converts this reaction information into a structured data object including a user identifier, an event identifier, a timestamp, and a payload field, and stores it temporarily in a transmission buffer.

### Step 2

The terminal transmits reaction information to the server via a communication network. The input is the structured reaction information object stored in the transmission buffer, and the output is a network message delivered to the server containing serialized reaction data. The terminal encodes the reaction information into a message format such as JSON, attaches session identifiers or authentication tokens, and sends the message using a protocol such as HTTP or WebSocket. The terminal then clears the transmission buffer entry or marks it as sent.

### Step 3

The server receives and stores the reaction information as time-series data. The input is the network message containing serialized reaction information, and the output is one or more database records and entries in a time-series buffer. The server parses the message to extract fields such as user identifier, event identifier, timestamp, and comment text or reaction code. The server writes these fields into a reaction information table in a storage device, assigning a reaction identifier. The server also appends the reaction identifier and corresponding timestamp to an in-memory data structure such as a ring buffer to maintain a time-ordered list of recent reactions.

### Step 4

The server constructs a batch of reaction information for emotion analysis. The input is the time-series buffer containing recent reaction identifiers and timestamps, and the output is a batch data structure containing reaction payloads grouped by a predetermined time window. The server selects reaction identifiers whose timestamps fall within a sliding time interval, retrieves their associated comment texts from the reaction information table, and aggregates these texts into a batch list. The server creates a batch object that includes the list of texts and associated metadata such as batch start and end times.

### Step 5

The server performs natural language processing on the batched reaction information to calculate emotion indexes. The input is the batch object containing reaction texts, and the output is an emotion index table containing, for each reaction, a numeric score and a categorical label. The server tokenizes each comment into tokens or subword units, maps each token to a numerical embedding, and passes the sequence of embeddings through a sentiment classifier implemented by a neural network. The server computes class probabilities for sentiment categories and converts them into an emotion index by applying a mapping function. The server records, for each reaction identifier, the emotion index and the corresponding label in the emotion index table.

### Step 6

The server aggregates emotion indexes to produce a crowd excitement level as an aggregate index. The input is a set of emotion indexes for reactions within a predetermined window, and the output is an aggregate index representing the crowd excitement level for that window. The server calculates statistical values such as the mean emotion index, the number of reactions, and the variance of the scores. The server combines these values using a predefined aggregation algorithm or lookup table to derive a crowd excitement level, which may be a continuous value or a discrete level such as low, medium, or high. The server stores the aggregate index and its associated time interval in an aggregate index table.

### Step 7

The server determines whether a new cheer should be generated based on the aggregate index and timing constraints. The input is the current aggregate index and a record of the last cheer generation time, and the output is a decision flag indicating whether to trigger cheer generation. The server compares the aggregate index with threshold values associated with different cheer intensities and checks whether a minimum interval has elapsed since the previous cheer. If the aggregate index exceeds a threshold and the interval condition is satisfied, the server sets the decision flag to true; otherwise, the server sets the decision flag to false and returns to monitoring new reaction data.

### Step 8

The server generates a prompt sentence for a generative AI model. The input is the aggregate index and the decision flag indicating that cheer generation is required, and the output is a prompt sentence in natural language. The server selects a prompt template corresponding to the crowd excitement level, such as a high-intensity or medium-intensity template, and replaces parameters within the template with context values such as duration category and component types. The server thus generates a specific prompt sentence, for example: “Please generate the sound of the audience cheering loudly.” or “Please express the scene where the audience gradually builds excitement and finally erupts in loud cheers through sound.” The server stores the generated prompt sentence in memory for use in the next step.

### Step 9

The server invokes the generative AI model using the prompt sentence and obtains generation result information. The input is the prompt sentence and model configuration parameters, and the output is a textual description or structured output describing characteristics of a crowd cheer. The server tokenizes the prompt sentence into token identifiers, feeds the token sequence into a generative AI model such as a transformer-based language model, and sets generation parameters including maximum output length and sampling temperature. The server receives the model's generated text, which may describe elements such as duration, intensity, and sound components, and stores this generated text as generation result information.

### Step 10

The server parses the generation result information to derive structured cheer parameters. The input is the generation result information in text form, and the output is a parameter sequence suitable for controlling audio synthesis. The server analyzes the text using pattern matching, rule-based extraction, or an auxiliary parser to identify numeric values such as time duration, linguistic indicators of intensity such as “very loud” or “subtle,” and mentions of sound components like “applause” or “whistles.” The server maps these extracted elements to numeric parameters including target duration in seconds, intensity level, component inclusion flags, and initial gain values. The server stores these numeric parameters in a structured parameter sequence data object.

### Step 11

The server selects pre-recorded crowd audio sources based on the parameter sequence. The input is the parameter sequence and audio asset metadata, and the output is a set of selected audio assets with associated initial gains and processing settings. The server queries the audio asset metadata to find candidate files that match required component types and approximate intensity levels, such as base crowd noise, applause, or whistles. The server chooses one or more assets for each component and assigns initial gain and equalization settings according to the intensity and mixing ratios defined in the parameter sequence. The server records the selections in a mixing configuration object.

### Step 12

The server performs audio signal processing to synthesize cheer audio data. The input is the mixing configuration object and the selected pre-recorded crowd audio sources, and the output is cheer audio data in a digital audio format. The server loads each audio file into memory, resamples them to a common sample rate, and adjusts their durations by trimming or time-stretching to match the target duration. The server applies equalization filters according to the desired frequency characteristics, adjusts levels according to the gain parameters, and applies panning or spatialization to position sound sources in a stereo or multi-channel field. The server mixes the processed signals by summing and normalizing them, and then encodes the result into a compressed audio format, storing the encoded cheer audio data in a storage device.

### Step 13

The server associates the cheer audio data with a time position in an audio-video signal and integrates the cheer into distribution media data. The input is the cheer audio data and timing information such as event timestamps and stream positions, and the output is updated distribution media data that includes the cheer audio. The server determines the insertion time by aligning the cheer audio with a target event in the timeline of the audio-video signal. The server uses a media processing engine to insert the cheer audio as an additional track or to mix it with the existing audio track around the target time position. The server then packages the resulting audio-video data into segments or files compatible with a streaming format and updates any associated index or manifest files.

### Step 14

The server adjusts the integrated cheer audio according to playback environment characteristics. The input is the distribution media data and configuration data describing acoustic conditions or terminal capabilities, and the output is distribution media data with modified cheer audio parameters. The server evaluates configuration parameters such as expected room size, typical output device type, and preferred loudness targets, and applies further signal processing such as reverberation adjustment, dynamic range compression, and equalization to optimize audibility and presence. The server regenerates or updates the affected media segments so that the cheer audio remains within a predetermined loudness and clarity range when mixed with other audio components.

### Step 15

The server transmits the distribution media data to the terminal over the communication network. The input is the finalized distribution media data including embedded cheer audio, and the output is a sequence of transmitted media segments or streams. The server exposes an endpoint that delivers audio-video segments according to client requests, manages buffering and adaptive bitrate logic if applicable, and streams the segments to the terminal using a network transport protocol. The server may log transmission status and performance metrics to monitor quality of service.

### Step 16

The terminal receives and decodes the distribution media data for playback. The input is the streamed media segments from the server, and the output is decoded audio samples and video frames ready for rendering. The terminal's media player downloads segment files, parses the container format to extract audio and video tracks, and decodes them using onboard codecs. The terminal synchronizes the decoded cheer audio with the corresponding video frames and original content audio based on timestamps within the stream.

### Step 17

The terminal outputs the synchronized audio, including the cheer audio data, to the user. The input is the decoded audio samples from the media player, and the output is an acoustic signal emitted by the terminal's speakers or headphones. The terminal applies local volume settings, optional equalization, and mixing with system sounds before sending the audio signal to the audio hardware. The terminal thereby renders the synthesized cheer audio in alignment with visual events, providing the user with an immersive sound experience.

### Step 18

The user experiences the playback and may provide further reactions that influence subsequent processing. The input is the audio-video content with embedded cheer audio as perceived by the user, and the output is additional user reactions such as new comments or reaction selections. The user responds to the enhanced experience by entering new text comments or tapping reaction controls. The terminal converts these new inputs into reaction information and transmits them to the server, which restarts the processing cycle beginning at the reaction acquisition step.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional character generation techniques using generative AI models typically rely on manually crafted prompt sentences that are typed or otherwise explicitly specified by a user. In such techniques, the computing system usually treats user voice merely as content to be synthesized or replayed, and does not exploit low-level acoustic properties of the voice as structured input for downstream generation. As a result, it is difficult for existing systems to automatically derive rich, machine-usable feature data from raw audio, to transform that feature data into consistent, high-quality prompt sentences, and to feed those prompt sentences into a generative AI model in a reproducible and computationally efficient manner.

Furthermore, many existing systems perform voice analysis in an ad hoc or shallow way, for example by using only coarse volume thresholds or simple pitch detection, without integrating systematic digital signal processing steps such as frame-based spectral analysis and robust feature extraction. This lack of a standardized processing pipeline leads to unstable character generation, limited personalization, and increased trial-and-error by the user when adjusting prompts. In addition, when conventional systems attempt to personalize characters based on user voice, the mapping from acoustic features to semantic descriptions is often implemented as informal heuristic code that is difficult to scale, optimize, or verify from a computer engineering standpoint.

From the viewpoint of computer technology, there is therefore a need for an improved technical framework that: (i) transforms raw audio signals into structured numerical feature vectors via a defined sequence of signal-processing operations on a processor; (ii) converts those feature vectors into natural-language prompt sentences in a deterministic and machine-controlled manner; and (iii) conditions a generative AI model on such prompt sentences to generate character data that is both computationally reproducible and better aligned with the acoustic “voice color” of the input audio. Without such a framework, the utilization of processor resources is suboptimal, the coupling between audio analysis and generative AI models remains loose and fragile, and the overall system fails to fully exploit the capabilities of modern computing architectures for personalized content generation.

Accordingly, the technical problem to be solved is to improve computer-implemented character generation by providing a processor-controlled pipeline that (a) acquires and digitizes voice input, (b) performs structured frame-based analysis to extract voice-color feature quantities, (c) automatically generates machine-targeted prompt sentences from those feature quantities, and (d) uses the generated prompt sentences to drive a generative AI model to produce character data, thereby improving consistency, efficiency, and personalization in the operation of the computing system.

The specific processing by the specific processing unit 290 of the data processing device 12 in Example 2 is realized by the following means.

The present invention provides a server comprising a processor and a memory storing instructions that, when executed by the processor, cause the processor to acquire sound from a subject and record the sound as a digital signal by using an input unit; to perform, by using an analysis unit, frequency analysis and time-domain analysis on the digital signal recorded by the input unit to extract voice-color feature quantities including at least pitch, sound pressure, frequency spectrum, and temporal variation; to determine, by using a prompt-generation unit, attribute information indicating an impression of the sound based on the extracted voice-color feature quantities and to generate a prompt sentence including the attribute information and the voice-color feature quantities, the prompt sentence being configured as an instruction sentence for generation processing; to receive the prompt sentence generated by the prompt-generation unit and to generate, by using a data-generation unit and a generative information-processing model, data including character data based on the prompt sentence; and to convert the character data generated by the data-generation unit into image data or display data and visually present the character data on a display device by using a display unit. This enables a computer-implemented pipeline in which raw audio is transformed into structured acoustic feature data, converted into machine-generated prompt sentences, and consumed by a generative AI model in a unified architecture, thereby improving the technical performance, reproducibility, and personalization capabilities of the character generation system.

The term “processor” refers to a hardware computation element, such as a central processing unit or a graphics processing unit, that executes machine-readable instructions to perform digital data processing.

The term “input unit” refers to a hardware and/or software component that acquires analog sound from a subject via a transducer and converts the sound into a digital signal suitable for processing by the processor.

The term “digital signal” refers to time-series data representing sampled and quantized values of an acoustic waveform that have been obtained from an analog sound by an analog-to-digital conversion process.

The term “analysis unit” refers to a hardware and/or software component that performs algorithmic processing on a digital signal, including at least frequency-domain and time-domain analysis, to extract numerical feature quantities.

The term “frequency analysis” refers to a computational procedure that transforms a time-domain digital signal into a representation in a frequency domain, for example by applying a fast Fourier transform to framed segments of the signal.

The term “time-domain analysis” refers to a computational procedure that operates on a digital signal in the time domain, including operations such as framing, windowing, amplitude measurement, and energy calculation over time.

The term “voice-color feature quantities” refers to numerical values that characterize perceptual properties of a sound, including at least pitch, sound pressure, frequency spectrum, and temporal variation of the acoustic signal.

The term “pitch” refers to a numerical representation of the perceived fundamental frequency of a sound, typically expressed as a frequency value in hertz derived from the periodicity of the digital signal.

The term “sound pressure” refers to a numerical measure of the amplitude or intensity of a sound, including quantities such as root-mean-square level or sound-pressure level, which indicate loudness in a digital representation.

The term “frequency spectrum” refers to a set of numerical values indicating the distribution of signal energy or magnitude as a function of frequency, obtained by transforming a time-domain digital signal into the frequency domain.

The term “temporal variation” refers to changes in one or more voice-color feature quantities over time, including fluctuations in pitch, amplitude, or spectral characteristics across successive time segments of the digital signal.

The term “attribute information” refers to symbolic or categorical data that expresses an impression or qualitative characterization of a sound, derived from voice-color feature quantities, such as an impression category describing the sound.

The term “prompt sentence” refers to a natural-language text string that includes voice-color feature quantities and attribute information and is configured as an instruction sentence for controlling generation processing by a generative model.

The term “prompt-generation unit” refers to a hardware and/or software component that receives voice-color feature quantities as input and generates a prompt sentence by determining attribute information and encoding it together with the feature quantities in natural language.

The term “generative information-processing model” refers to a machine-learned computational model that receives input data, including at least a prompt sentence, and outputs newly generated data by performing sequential inference processing or probabilistic generation processing.

The term “data-generation unit” refers to a hardware and/or software component that supplies a prompt sentence to a generative information-processing model and obtains, as output, generated data including character data corresponding to the prompt sentence.

The term “character data” refers to structured data describing at least appearance information and optionally personality information of a character, generated by a generative information-processing model in response to a prompt sentence.

The term “appearance information” refers to data defining visual properties of a character, including at least shape, color, pose, clothing, or other graphical attributes used to render the character in an image.

The term “personality information” refers to data describing non-visual attributes of a character, including at least traits, tendencies, or behavioral characteristics expressed in textual or symbolic form.

The term “display unit” refers to a hardware and/or software component that converts character data into image data or display data and presents the resulting visual representation on a display device.

The term “image data” refers to digital data defining a two-dimensional or three-dimensional visual representation, including at least pixel values or equivalent graphical primitives used to render an image.

The term “display data” refers to digital data in a format suitable for direct presentation on a display device, including at least processed image data, layout information, and associated control information for rendering.

In one embodiment, a server, a terminal, and a user cooperate to implement the invention. The server comprises at least one processor, a memory, a storage device, and a network interface. The terminal comprises at least one processor, a memory, a microphone, a display, and a communication interface. The user interacts with the terminal to provide voice input and to view generated character content.

The server executes a software stack including an operating system, a web application framework, and a generative AI inference engine. The server may employ a general-purpose processor and a graphics processing unit. The graphics processing unit executes a neural network model used as a generative AI model. The generative AI model may be implemented using a deep learning framework such as a generic tensor computation library. The generative AI model may have an encoder-decoder architecture or a diffusion-based architecture, where a text encoder (for example, a transformer-based encoder) converts a prompt sentence into a latent conditioning vector, and a decoder or diffusion module generates image data corresponding to the prompt sentence.

The terminal executes an application that performs audio capture, signal processing, prompt generation, network communication, and display control. The terminal can execute an audio capture module using an audio API provided by the operating system, such as a generic mobile audio API. The audio capture module controls the microphone to acquire analog sound from the user, such as a cheer or other vocal expression, and converts the sound into a digital signal using an analog-to-digital converter. The terminal stores the digital signal in a storage area as a waveform file in a format such as linear PCM in a container format such as a waveform audio file format.

The terminal executes an analysis module that implements digital signal processing routines. The analysis module divides the digital signal into overlapping frames of fixed duration and applies a window function, such as a Hamming window, to each frame. The analysis module computes, for each frame, a fast Fourier transform to obtain a complex spectrum, and from this spectrum calculates a magnitude spectrum. The analysis module then derives numerical feature quantities, including a fundamental frequency estimate, a sound-pressure level, and spectral descriptors such as a spectral centroid and a spectral bandwidth. The analysis module may further compute cepstral coefficients, such as Mel-frequency cepstral coefficients, to characterize timbre.

The terminal uses a pitch detection algorithm such as an autocorrelation-based method or a YIN-type method. The terminal calculates, for each frame, an autocorrelation function or difference function over a range of lags, identifies a lag value corresponding to a minimum of the difference function or a maximum of the autocorrelation, and converts the lag value to a fundamental frequency in hertz. The terminal filters out unreliable frame estimates based on an energy threshold and a voicing decision, and averages the remaining fundamental frequency values to obtain an average pitch and a pitch variance.

The terminal calculates a sound-pressure level by computing a root-mean-square value for each frame and converting the value to a decibel scale relative to a reference amplitude. The terminal calculates a spectral centroid by weighting each frequency bin in the magnitude spectrum by its center frequency and normalizing by the total spectral energy. The terminal constructs a feature vector for the entire utterance, including at least the average pitch, the pitch variance, the average sound-pressure level, the maximum sound-pressure level, the average spectral centroid, and, optionally, a fixed-length vector of cepstral coefficients.

The terminal executes a prompt-generation module that converts the numerical feature vector into a prompt sentence. The prompt-generation module may implement a rule-based mapping or a trained classifier. In a rule-based embodiment, the terminal applies threshold-based rules to the feature vector. For example, the terminal may classify the voice as “high-pitched and energetic” when the average pitch exceeds a predetermined frequency threshold, the average sound-pressure level exceeds a predetermined loudness threshold, and the average spectral centroid exceeds a predetermined brightness threshold. The terminal may classify the voice as “low and calm” when the average pitch is below a lower threshold, the sound-pressure level falls within a moderate range, and the spectral centroid is below a brightness threshold.

The terminal then assembles a natural-language description by inserting the classification label and numerical values into a template. For example, when the feature vector indicates a high average pitch and high loudness, the terminal may generate a prompt sentence such as: “Generate a bright, energetic anime-style character based on a high-pitched, excited cheer with an average pitch of 360 Hz and high volume. The character should be smiling widely, with vivid colors and a dynamic pose.”

When the feature vector indicates a low average pitch and low spectral centroid, the terminal may generate a prompt sentence such as:
“Generate a calm and reliable character based on a low-pitched, relaxed cheer. The character should have a gentle expression, subdued colors, and a composed posture.”

The terminal may generate other prompt sentences corresponding to different feature combinations, such as:
“Generate a heroic character with a bold personality and rugged appearance based on a voice with moderate pitch, high volume, and a slightly rough timbre, similar to a passionate cheer in a stadium.”

The terminal can store the prompt sentence as a character string in a structured data object together with the feature vector and metadata. The prompt-generation module therefore imposes a fixed, machine-controlled format on the prompt sentence, embedding acoustic information that is not normally exposed to end users. This structured mapping from continuous acoustic space to discrete prompt space improves reproducibility and consistency in the subsequent generative processing.

The server receives the prompt sentence from the terminal through a network communication module. The server exposes an application programming interface that accepts the prompt sentence and additional parameters such as desired image resolution and style. The server parses the incoming request, extracts the prompt sentence, and forwards it to the generative AI model. The generative AI model may be a neural network such as a text-to-image diffusion model. The model includes a text encoder that converts the prompt sentence into a sequence of token embeddings and then into a latent representation using multiple self-attention layers and feedforward layers. The model also includes a denoising network, such as a convolutional neural network or a U-Net architecture, that iteratively refines a noisy latent image representation under the conditioning of the text-derived latent representation.

The generative AI model is trained in advance using a training dataset of text-image pairs. During training, the server executes a learning process on the graphics processing unit. The server applies data augmentation to image inputs, such as random cropping, random resizing, and color jittering, and tokenizes text inputs into subword units. The server defines a loss function such as a mean-squared error between predicted noise and actual noise in a diffusion step, or a cross-entropy between predicted tokens and ground-truth tokens in a language model. The server updates the network weights by backpropagation and stochastic gradient descent or a variant such as Adam. The training process yields model parameters that encode correlations between textual descriptions and visual features.

At inference time, the server initializes a random latent representation sampled from a predetermined distribution, such as a normal distribution, and iteratively applies the denoising network while conditioning on the latent text representation of the prompt sentence. At each denoising step, the server computes predicted noise and subtracts it according to a scheduled noise level, thereby moving the latent representation toward a sample that is consistent with the prompt. When the denoising process is complete, the server applies a decoder or a projection module to obtain image data in the form of a multi-channel pixel array. The server may additionally generate symbolic character data such as a personality description by feeding the same prompt sentence into a language model and generating text tokens that describe character traits.

The server returns the generated character data, including at least an image or an image identifier and optional personality information, to the terminal. The terminal receives the response and, if the server returns an image file identifier, downloads the corresponding image data from a content storage system. The terminal decodes the image data using a graphics library and converts the data into a format suitable for display on the display device, such as a raster image buffer with a specific width, height, and color format. The terminal renders the character image within a user interface layout, optionally along with a textual description derived from the personality information provided by the server.

The server and the terminal thereby cooperate to implement an end-to-end pipeline that transforms raw acoustic signals into visually presented personalized characters. This pipeline is not limited to generic data acquisition, but uses specific data structures and algorithms: a frame-based digital signal representation, a structured numerical feature vector, a deterministic mapping to a prompt sentence, and a generative AI model conditioned on the prompt sentence. By tightly coupling these stages within a single system, the invention improves technical aspects of computer operation.

First, the server and the terminal reduce computational load and network traffic by performing low-level signal processing and feature extraction on the terminal. The terminal transmits compact feature-derived prompt sentences instead of bulky raw audio data, thereby reducing communication bandwidth and latency. The deterministic feature extraction and classification reduce noise in the prompt space, which leads to fewer generation retries and more stable outputs, improving overall processing efficiency and response time.

Second, the terminal and the server improve generation accuracy and personalization by embedding quantitative acoustic properties directly into the prompt sentence. Because the prompt sentence includes structured references to pitch, loudness, and timbre patterns, the generative AI model receives richer conditioning information than in conventional systems where a user manually enters vague text prompts. The server can also tune the generative model or apply specialized conditioning layers that are designed to respond to specific acoustic features encoded in the prompt. This arrangement reduces the variance of generated outputs with respect to small changes in input voice and thereby lowers the error rate in matching user expectations.

Third, the server and the terminal implement a non-conventional, rule-based and model-based mapping from acoustic feature space to semantic label space. This mapping is not merely an automation of human subjective judgment, but uses predefined mathematical thresholds, classification rules, and possibly a lightweight neural classifier to derive impression categories in a consistent and machine-verifiable manner. For example, the terminal may implement a classifier that takes the feature vector as input and outputs one of several impression classes using a small feedforward network with rectified linear units and a softmax output. The classifier is trained with labeled data where each sample associates a feature vector with an impression category such as “cheerful,” “calm,” or “powerful,” using a cross-entropy loss and gradient descent. This structured mapping allows the system to scale to large numbers of users while maintaining consistent behavior.

Fourth, the use of a specific processing flow—framing, windowing, fast Fourier transform, feature extraction, classification, prompt generation, and conditioned generation—improves computer technology by enabling the server to reuse intermediate representations across multiple invocations. For example, the terminal can cache feature vectors and prompt sentences for repeated or batched processing, and the server can cache text encoder outputs for similar prompts. These designs reduce redundant computation, improve throughput on the server-side graphics processing unit, and facilitate parallelization.

In an alternative embodiment, the terminal incorporates a local generative AI model instead of relying on a remote server. The terminal may then execute a reduced-size neural network, such as a quantized diffusion model or a lightweight generative adversarial network, using a mobile inference engine. The terminal still executes the same feature extraction and prompt generation steps. In this configuration, the terminal avoids network transmission overhead entirely and can generate character data in a disconnected environment. This embodiment improves latency and privacy by keeping raw and processed voice data on the terminal.

In another embodiment, the server supports multiple types of generative AI models. The server may use a text-to-image model to generate an image of a character and a text-to-text model to generate a narrative description or dialogue for the character. Both models receive the same prompt sentence or variants derived from the prompt sentence. The server may assemble a composite character profile that includes image data, personality traits, and suggested behavior scripts. The terminal can then display the image together with the textual profile, or can pass the profile to another subsystem, such as an interactive application, which renders the character in a real-time scene.

In further embodiments, the server and the terminal can adapt the feature extraction parameters and prompt-generation templates based on user preferences or application constraints. For high-precision applications, the analysis module may use a higher sampling rate and longer frame sizes to obtain more accurate spectral estimates. For low-latency applications, the analysis module may use shorter frames and reduced feature sets. The prompt-generation module may switch between concise and detailed templates depending on the computational budget available on the server. These variations demonstrate that the invention provides a flexible yet technically grounded framework for controlling generative AI models based on acoustically derived prompts.

Because the invention defines specific data structures (feature vectors, prompt sentences), processing modules (analysis unit, prompt-generation unit, data-generation unit), and algorithmic flows (frame-based spectral analysis, rule-based classification, conditioned generative inference), and because the invention improves the efficiency, accuracy, and resource utilization of the underlying computing devices, the invention goes beyond a mere automation of human mental activity or business practice. The server and the terminal operate in concert to implement a technical solution that enhances computer functionality in the context of generative AI-based character generation.

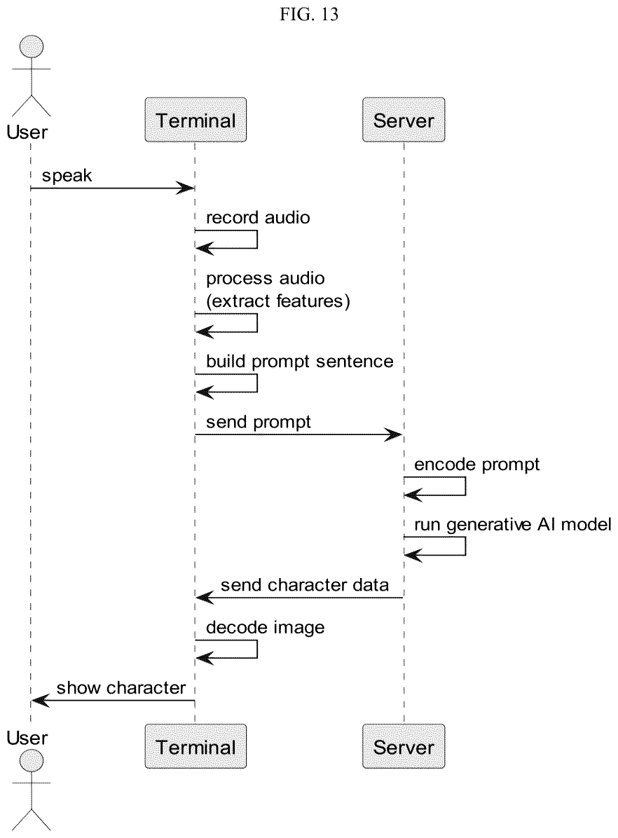

The following describes the processing flow using FIG. 13.

### Step 1

The user provides a vocal input.

The user positions the mouth near the terminal's microphone and utters a cheer or other vocal expression.

Input: No digital data; the input is an analog acoustic pressure wave generated by the user's voice.

Output: The terminal receives an analog sound signal at the microphone input.

### Step

The terminal converts the analog sound into a digital signal.

The terminal controls the microphone via an audio API to sample the analog signal at a fixed sampling rate (for example, 44.1 kHz, 16-bit, mono). The terminal uses an analog-to-digital converter to quantize the amplitude of the acoustic wave into discrete sample values and buffers these values in memory.

Input: The analog sound signal received from the microphone.

Output: A time-series array of digital samples representing the user's voice, for example an array of 16-bit integers in a linear PCM format.

### Step 3

The terminal stores the digital signal as an audio file.

The terminal passes the array of samples to a file I/O module and writes the samples to persistent storage in a container format, such as a waveform audio file format, including header information such as sampling rate, bit depth, and channel count.

Input: The time-series array of digital samples.

Output: A digital audio file stored in the terminal's storage, such as “user_cheer.wav.”

### Step 4

The terminal loads and normalizes the audio signal.

The terminal reads the audio file from storage into memory using an audio decoding routine. The terminal scans all sample values to find the maximum absolute amplitude, divides each sample by this maximum to normalize the values into a fixed range, and optionally removes leading and trailing silence based on an amplitude threshold.

Input: The digital audio file representing the user's voice.

Output: A normalized waveform array in memory, with silence-trimmed samples represented as floating-point values.

### Step 5

The terminal segments the waveform into frames and applies a window function.

The terminal divides the normalized waveform into overlapping frames of a predetermined length (for example, 25 ms) with a predetermined shift (for example, 10 ms). The terminal multiplies each frame by a window function, such as a Hamming window, to reduce spectral leakage.

Input: The normalized waveform array.

Output: A sequence of windowed frames, where each frame is an array of sample values prepared for spectral analysis.

### Step 6

The terminal performs a fast Fourier transform for each frame and computes spectral features.

The terminal calls a digital signal processing library to compute a fast Fourier transform on each windowed frame, producing complex-valued spectra. The terminal converts the complex spectra to magnitude spectra, and for each frame, calculates spectral descriptors such as a spectral centroid and spectral bandwidth by summing frequency-bin values weighted by frequency indices.

Input: The sequence of windowed frames.

Output: A sequence of magnitude spectra and frame-wise spectral feature values, including at least spectral centroid and spectral bandwidth per frame.

### Step 7

The terminal estimates pitch and sound-pressure level over time.

The terminal applies a pitch detection algorithm to each frame by computing an autocorrelation or difference function over a range of lags, locating the lag corresponding to the fundamental period, and converting the lag to a frequency in hertz. The terminal discards unreliable estimates using an energy threshold. The terminal also computes a root-mean-square value for each frame and converts it to a sound-pressure level in decibels.

Input: The sequence of windowed frames and corresponding magnitude spectra.

Output: Frame-wise pitch values, frame-wise sound-pressure levels, and reliability flags for each frame.

### Step 8

The terminal aggregates frame-wise features into a global voice-color feature vector.

The terminal selects frames marked as reliable and computes statistical measures such as an average pitch, pitch variance, average sound-pressure level, maximum sound-pressure level, and average spectral centroid across the selected frames. The terminal optionally aggregates cepstral coefficients into a fixed-length vector by averaging or pooling.

Input: Frame-wise pitch values, sound-pressure levels, spectral centroids, and optional cepstral coefficients.

Output: A global feature vector representing voice-color feature quantities for the utterance, including at least average pitch, pitch variance, average loudness, maximum loudness, and average spectral centroid.

### Step 9

The terminal classifies the impression of the voice based on the feature vector.

The terminal applies a rule set or a trained classifier to the feature vector. For a rule set, the terminal compares average pitch, loudness, and spectral centroid with stored thresholds to assign an impression category such as “high-pitched and energetic” or “low and calm.” For a classifier, the terminal feeds the feature vector into a small neural network or decision tree and reads the output category with the highest probability.

Input: The global voice-color feature vector.

Output: An impression label or category indicating the perceived style of the voice, for example “high-pitched and energetic.”

### Step 10

The terminal generates a prompt sentence using the feature vector and impression label.

The terminal selects a natural-language template corresponding to the impression label from a template set stored in memory. The terminal inserts numerical feature values, such as average pitch in hertz and qualitative loudness descriptors, into placeholder positions of the template to form a complete prompt sentence.

Input: The global voice-color feature vector and the impression label.

Output: A prompt sentence in natural language, such as “Generate a bright, energetic anime-style character based on a high-pitched, excited cheer with an average pitch of 360 Hz and high volume. The character should be smiling widely, with vivid colors and a dynamic pose.”

### Step 11

The terminal constructs a request to the server containing the prompt sentence.

The terminal creates a data structure that includes the prompt sentence and optional parameters such as requested image style and resolution. The terminal uses a communication library to format this data into a request message and prepares it for transmission over a network protocol.

Input: The prompt sentence and generation parameters.

Output: A network request message ready to be sent to the server.

### Step 12

The terminal transmits the request to the server.

The terminal uses its communication interface to open a network connection to the server and sends the request message over the network using a protocol such as HTTPS. The terminal then waits for a response while maintaining the connection state.

Input: The network request message.

Output: The request is delivered to the server, and the server-side application receives the prompt sentence and parameters.

### Step 13

The server parses the received request and extracts the prompt sentence.

The server's application framework accepts the incoming message, decodes the message body, and reads the fields containing the prompt sentence and parameters. The server validates the content length and syntax to ensure the data is suitable for further processing.

Input: The network request message received from the terminal.

Output: An internal representation of the prompt sentence and associated parameters held in the server's memory.

### Step 14

The server encodes the prompt sentence into a latent representation for the generative AI model.

The server tokenizes the prompt sentence into a sequence of tokens using a tokenizer associated with the generative AI model. The server maps tokens to token IDs, looks up corresponding embeddings, and passes the sequence through a text encoder, such as a multi-layer transformer. The server computes self-attention and feedforward operations layer by layer to produce a latent conditioning vector.

Input: The prompt sentence extracted from the request.

Output: A latent text representation that encodes the semantics of the prompt sentence for use by the generative AI model.

### Step 15

The server executes a generative AI model to generate character data.

The server initializes a latent image representation by sampling from a predefined distribution. The server passes the latent image representation and the latent text representation to a denoising network, such as a U-Net, and iteratively updates the latent image representation over multiple steps. At each step, the server computes a predicted noise component conditioned on the text representation and subtracts it according to a noise schedule. After all steps, the server decodes the refined latent image representation into pixel values.

Input: The latent text representation derived from the prompt sentence and an initial latent image representation.

Output: Generated character data that includes at least pixel data for an image corresponding to the prompt sentence.

### Step 16

The server optionally generates personality information associated with the character.

The server forwards the same prompt sentence, or a derived variant, to a language-generation module that may share or be separate from the image model. The server encodes the text, performs sequential token prediction using a language model, and produces a description of character traits, behavior, or background.

Input: The prompt sentence and optional auxiliary parameters.

Output: Textual personality information describing the character in terms of traits or behavior.

### Step 17

The server prepares a response containing the generated character data.

The server converts the pixel data into an image format such as a compressed image file and optionally stores it in a storage system. The server composes a response object that includes either the image data or a reference to the stored image, along with any personality information.

Input: The image pixel data and optional personality text produced by the generative AI model.

Output: A response message containing character data ready to be sent back to the terminal.

### Step 18

The server transmits the response to the terminal.

The server uses its network interface to send the response message over the network connection initiated by the terminal. The server ensures that the message headers and body are correctly formed and closes or maintains the connection according to protocol requirements.

Input: The response message containing character data.

Output: The response is delivered to the terminal, and the terminal-side communication module receives the message.

### Step 19

The terminal receives the response and obtains the character data.

The terminal's communication module reads the incoming response, checks the status field, and extracts the sections corresponding to image data or image references and personality text. If the response contains an image reference, the terminal performs a follow-up retrieval to fetch the associated image bytes.

Input: The response message from the server.

Output: Raw image data and optional personality text stored in the terminal's memory.

### Step 20

The terminal decodes the image data and prepares it for display.

The terminal calls a graphics decoding library to convert the compressed image data into a raster representation, such as an array of pixels in a specific color format. The terminal allocates a frame buffer on the display subsystem and copies or maps the pixel data into this buffer.

Input: The raw image data representing the generated character image.

Output: A decoded image buffer that can be rendered on the terminal's display.

### Step 21

The terminal displays the generated character to the user.

The terminal renders the decoded image buffer within a user interface layout on the display device, positioning the image in a designated region. The terminal may also render the personality text as captions or descriptive text near the image.

Input: The image buffer and optional personality text.

Output: A visual presentation of the character image and associated information on the display, which the user can see and interpret.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional content delivery systems and interaction systems primarily treat user audio as a simple trigger or passive media stream. In such systems, user cheers, shouts, or other vocal reactions are merely recorded or mixed into audio output without being structurally analyzed and without being fed back into the core logic of content generation. As a result, these systems do not fully utilize the rich information contained in user audio, such as acoustic features and emotional content, and therefore cannot dynamically adapt virtual entities or digital content behavior in a fine-grained and context-sensitive manner.

In typical implementations, if a system attempts to personalize or adapt content, the server often relies on predefined rule sets or static mappings from coarse events (for example, “user pressed like button”) to preauthored responses (for example, “play pre-recorded animation A”). This architecture limits scalability and expressiveness, and imposes significant manual authoring cost. Furthermore, known generative systems that employ machine learning models usually accept a manually crafted text prompt that is not systematically derived from multimodal user data captured at runtime. Therefore, these systems cannot efficiently or reliably convert raw, noisy, real-time audio reactions into structurally consistent prompt sentences suitable for use by a generative AI model.

In addition, existing interactive character and asset systems do not provide an integrated pipeline that: (i) acquires user audio in real time, (ii) extracts acoustic feature information and emotion information from the audio, (iii) composes a machine-interpretable and natural-language prompt sentence from these analysis results, (iv) invokes a generative AI model based on the prompt sentence to synthesize description information of a virtual entity, (v) generates corresponding visual or auditory expression information, (vi) materializes the result as a structured digital asset, and (vii) continuously updates the behavior and expressions of the virtual entity in response to subsequent user operations or additional audio. In known architectures, each of these functionalities is either absent, siloed, or requires manual intervention, which prevents fully automated, low-latency, and context-aware interaction.

Consequently, there is a need for a technical solution that improves computer technology by providing a server-side processing architecture that automatically converts real-time audio signals into structured representations, synthesizes appropriate prompt sentences, and drives a generative AI model so as to generate and update virtual entities, expression information, and digital assets in a consistent, scalable, and computationally efficient manner. Such a solution should reduce manual authoring, lower latency, and enhance system-level adaptability, thereby improving the overall performance and functionality of content delivery platforms, interaction engines, and digital asset management systems.

The specific processing by the specific processing unit 290 of the data processing device 12 in Application Example 2 is realized by the following means.

The present invention provides a server comprising a processor configured to acquire sound information of a subject from an information processing terminal and store the sound information as digital audio data; analyze the acquired sound information to identify acoustic feature information and emotion information; construct, on the basis of the acoustic feature information and the emotion information, a prompt sentence to be input to a generative AI model, the prompt sentence being generated by converting structured data including the acoustic feature information, the emotion information, and character string information obtained from the sound information into a natural-language form; input the prompt sentence to the generative AI model and generate, by using the generative AI model, description information of a virtual entity; generate visual expression information or auditory expression information of the virtual entity on the basis of the description information of the virtual entity, including determining expression parameter information in accordance with a state of event-providing content and generating the visual expression information or the auditory expression information in a form suitable for an event-providing display device or an acoustic device; generate digital asset information corresponding to the virtual entity and distribute the digital asset information to the information processing terminal; receive operation information or additional sound information from the information processing terminal, update the prompt sentence for the generative AI model in response to the operation information or the additional sound information, and generate response behavior information of the virtual entity on the basis of the updated prompt sentence; and update the visual expression information or the auditory expression information on the basis of the response behavior information and present updated expression information to the information processing terminal or to the display device. This enables efficient and automated conversion of real-time user audio into structured prompts and corresponding virtual entity behavior, improves the adaptability and responsiveness of the server-side processing pipeline, reduces reliance on manually authored content, and enhances the technical performance of interactive content delivery and digital asset generation systems.

The term “sound information” refers to information representing an acoustic signal, including but not limited to human voice, crowd noise, music, or environmental sounds, acquired in analog or digital form and processable by an information processing device.

The term “digital audio data” refers to sound information that has been converted into a numerical representation, such as pulse code modulated data or compressed audio data, suitable for storage, transmission, and computation by a processor.

The term “acoustic feature information” refers to numerical or symbolic information obtained by analyzing digital audio data, including characteristics such as pitch, loudness, spectral distribution, temporal envelope, speaking rate, or other derived parameters that describe properties of the sound.

The term “emotion information” refers to information indicating an estimated affective state associated with sound information, such as joy, excitement, sadness, anger, or calmness, optionally including an intensity value or confidence value for each estimated state.

The term “character string information” refers to textual information obtained from sound information, such as a transcription result of spoken words, and may include individual characters, words, or sentences represented in a character encoding scheme.

The term “structured data” refers to data in which elements such as acoustic feature information, emotion information, and character string information are organized according to a predefined schema, format, or data structure that enables systematic processing by a program.

The term “prompt sentence” refers to a natural-language expression generated on the basis of structured data and configured to be input to a generative AI model so as to specify a generation task, constraints, or desired characteristics of an output.

The term “generative AI model” refers to a machine learning model that receives a prompt sentence or other conditioning information and automatically generates new data, such as textual description information, image data, audio data, or other content, according to learned patterns.

The term “description information of a virtual entity” refers to information specifying attributes of a computationally represented entity, including one or more of appearance, behavior, personality, role, dialogue, or contextual properties that can be used to generate expression information.

The term “virtual entity” refers to an entity represented in a digital environment, such as a character, avatar, agent, or object, that can be displayed, animated, or otherwise expressed visually or audibly, and that can change state in response to processing by a system.

The term “visual expression information” refers to information used to render a graphical or image-based representation of a virtual entity, including model identifiers, texture data, color information, pose data, animation sequences, or layout parameters.

The term “auditory expression information” refers to information used to output a sound-based representation of a virtual entity or event, including synthesized voice data, effect sounds, or other audio content associated with behavior or state of the virtual entity.

The term “expression parameter information” refers to information that controls how visual expression information or auditory expression information is generated or modified, such as brightness, color tone, motion speed, volume level, or timing relative to content.

The term “event-providing content” refers to content that presents an event or experience to a user, such as a live performance, recorded program, interactive session, or simulation, which can be displayed or reproduced by a content delivery system.

The term “event-providing display device” refers to a device configured to present event-providing content visually, such as a monitor, projection screen, head-mounted display, or other image output apparatus.

The term “acoustic device” refers to a device configured to output audio signals, such as a loudspeaker, headphone, soundbar, or other sound reproduction apparatus.

The term “digital asset information” refers to information representing a digital item associated with a virtual entity, including identification data, ownership data, and metadata, which can be stored, transferred, or managed by an information processing system.

The term “information processing terminal” refers to a computing apparatus operated by a user, such as a mobile terminal, personal computer, game device, or head-mounted device, that can transmit and receive data to and from a server.

The term “operation information” refers to information representing user input to an information processing terminal, including pointer operations, touch inputs, key inputs, gesture inputs, or selection operations related to a virtual entity or content.

The term “additional sound information” refers to sound information acquired after initial processing, such as subsequent user speech or cheers, that is used to update or refine a prompt sentence or behavior of a virtual entity.

The term “response behavior information” refers to information indicating one or more actions, reactions, or state changes of a virtual entity, including motion patterns, expression changes, utterances, or other behaviors generated in response to input.

In one embodiment, a server, a terminal, and a user cooperate to implement the claimed system. The server includes at least one processor, a main memory, a non-volatile storage device, and one or more network interfaces. The terminal includes a processor, a memory, a microphone, a display device, and a communication interface. The user operates the terminal to provide sound information and operation information.

### A. Overall configuration

The server executes a plurality of software modules stored in the non-volatile storage device and loaded into the main memory. The modules include an audio acquisition module, an audio analysis module, an emotion estimation module, a text processing module, a prompt construction module, a generative AI interface module, a virtual entity description module, an expression generation module, a digital asset management module, and a communication control module.

The terminal executes an application that includes an audio capture component for controlling the microphone, a rendering component for presenting visual expression information, a playback component for presenting auditory expression information, and a user input component for collecting operation information and additional sound information.

The user operates the terminal application to initiate recording, to view or listen to generated expressions, and to interact with virtual entities.

### B. Hardware and Software for Audio Acquisition and Analysis

The terminal uses an operating system-specific audio API, such as an audio capture interface in a mobile operating system, to sample sound information at a predetermined sampling rate (for example, 16 kHz to 48 kHz) and bit depth (for example, 16-bit PCM). The terminal converts the analog sound captured by the microphone into digital audio data and stores the data in a buffer in memory before transmitting it to the server over a communication network using a transport protocol such as HTTPS.

The server receives the digital audio data via the communication control module and stores the data in a structured format, for example as a waveform file or as a sequence of time-stamped audio frames. The server uses an audio analysis library, such as a general-purpose audio feature extraction library, to compute acoustic feature information, including at least one of: a pitch contour obtained by autocorrelation or cepstral analysis, an energy envelope obtained by frame-wise power computation, spectral descriptors such as spectral centroid and spectral flatness, and temporal descriptors such as zero-crossing rate and speaking rate. The server represents the acoustic feature information in a feature vector sequence where each element corresponds to a feature for a particular time frame. The server may further normalize these features using global means and variances pre-computed from training data.

The server uses a speech recognition engine, such as a cloud-based speech-to-text service, to convert the digital audio data into character string information. The server feeds the digital audio data into the speech recognition engine and receives recognized text along with confidence scores for each recognized segment. The server stores the recognized text as character string information in association with the corresponding digital audio data.

### C. Emotion Estimation and Structured Data Construction

The server applies an emotion estimation module that implements a neural network-based classifier to the acoustic feature information and the character string information. In one example, the server uses a neural network having an input layer for acoustic features, a plurality of hidden layers including at least one recurrent layer or convolutional layer, and an output layer that outputs probability values for a plurality of emotion categories such as joy, excitement, sadness, anger, or calmness. The server trains this neural network in advance using supervised learning, where training data include labeled pairs of audio features and ground truth emotion labels.

During training, the server divides training audio into frames, computes acoustic features, and feeds sequences of acoustic feature vectors into the neural network. The server defines a loss function, such as a cross-entropy loss between predicted emotion probabilities and true labels. The server updates the weights of the neural network using a gradient-based optimization algorithm, such as stochastic gradient descent with momentum or an adaptive method. The server may use techniques such as dropout and batch normalization to improve generalization ability. The server may augment the training data using operations such as time stretching, pitch shifting, or additive noise to increase robustness.

At inference time, the server feeds the acoustic feature information for the user's audio into the trained neural network and obtains emotion information, which includes at least one emotion label and associated probability or intensity values. The server optionally combines this audio-based emotion with text-based sentiment analysis, performed by the text processing module using a separate classifier applied to the character string information, and fuses the results using a rule-based or learned fusion strategy, such as weighted averaging based on confidence scores.

The server constructs structured data that includes the acoustic feature information, the emotion information, and the character string information. The server uses a data structure, such as a record or object, that contains fields for voice-color attributes (for example, high pitch, high energy), emotion labels and scores, and recognized words and phrases. The server may store multiple structured data instances in a time-ordered list when multiple user utterances are processed within one session.

### D. Prompt Sentence Generation and Generative AI Model

The server uses the prompt construction module to convert the structured data into a prompt sentence for use by a generative AI model. The server uses predetermined templates in which variable parts are filled by values from the structured data. For example, the server may construct the following prompt sentence:
“User's cheer: ‘Awesome!’. Voice color: high pitch, loud, fast tempo. Emotion: strong joy. Event type: live concert. Please generate an energetic mascot character who cheers together with the user and fits a live concert setting.”

The server may construct other prompt sentences depending on context, such as:
“Based on audience feedback, please generate an energetic character perfect for live events.” or:
“Voice color: high pitch and strong intensity. Emotion: excitement. Please generate a bright character that sends an encouraging message during a movie climax.”

The server represents the prompt sentence as a sequence of tokens compatible with the generative AI model's input format.

In one embodiment, the server uses a generative AI model having a transformer-based architecture, including multiple self-attention layers, feed-forward layers, and layer normalization. The server trains the generative AI model using large-scale textual data such that the model learns to predict a next token given a sequence of preceding tokens. During inference, the server sets sampling parameters such as temperature and top-k or top-p values to control diversity and coherence.

The server sends the prompt sentence to the generative AI model via the generative AI interface module and obtains generated output that comprises description information of a virtual entity. The generated description information may be a natural-language text that includes attributes of the virtual entity, such as appearance, personality, typical actions, and recommended utterances.

The server parses the generated description information using a parsing algorithm, such as a rule-based parser or another language model, to extract structured attributes. For example, the server extracts appearance attributes (for example, color palette, body shape, accessories), behavior attributes (for example, jumping, waving, cheering), and dialogue templates (for example, typical cheering phrases).

### E. Generation of Expression Information

The server uses the expression generation module to map the description information into visual expression information and auditory expression information. The server may maintain a template library containing a plurality of base character models and animation sets. Each base character model has associated metadata describing stylistic properties.

The server compares the attributes of the virtual entity with metadata of the base character models and selects a base model whose metadata best matches the description information, for example by computing a similarity score between attribute vectors. The server then applies parameter adjustments derived from the description information, such as changing color values, scaling body proportions, or selecting specific animation clips, to generate visual expression information. The server encodes the visual expression information using a structured format, such as a JSON descriptor that references texture files, mesh data, and animation tracks.

For auditory expression information, the server may generate character-specific voice lines by constructing additional prompt sentences that describe desired voice characteristics and text content. For example, the server may construct a prompt sentence such as:
“Generate a short cheering phrase spoken by an energetic mascot that reflects strong joy.”

The server may then use a text-to-speech engine combined with a parametric voice model to synthesize audio that corresponds to the phrase. Parameters for pitch, speed, and timbre may be derived from the emotion information and voice-color attributes to ensure coherence between user audio and generated audio.

The server determines expression parameter information that adapts expression intensities to a state of event-providing content. For instance, the server may increase character motion amplitude and brightness when the associated event is in a climax state, and may lower movement speed during calmer scenes. The server obtains event state information from an event controller or content timeline and calculates expression parameter information such as brightness values, motion speed scaling factors, and audio gain levels.
F. Digital Asset Generation and Distribution

The server uses the digital asset management module to generate digital asset information corresponding to the virtual entity. The server composes metadata including an identifier for the virtual entity, a description of the entity's attributes, a record of the originating audio and emotion information, and ownership data associated with the user. The server may optionally register the asset in a distributed ledger system, but the invention is not limited thereto.

The server stores the digital asset information in a digital asset database and assigns a unique asset identifier. The server transmits the digital asset information, including the asset identifier and selected metadata, to the terminal via the communication control module. The terminal displays the digital asset as an item in a collection screen and may allow the user to select or activate the asset for later sessions.
G. Interaction and Prompt Updating

The terminal renders the virtual entity on the display by using the visual expression information delivered by the server. The terminal displays the virtual entity overlaid on event-providing content or in a dedicated view, and the terminal plays auditory expression information through the acoustic device.

The user interacts with the virtual entity by performing operations such as tapping, dragging, or issuing additional speech. The terminal captures operation information, such as coordinates of touch events and event types, and may capture additional sound information through the microphone. The terminal transmits these data to the server.

The server receives the operation information and the additional sound information. The server may analyze the additional sound information using the same pipeline as initial sound acquisition, extracting acoustic feature information, emotion information, and character string information. The server updates the structured data with new values and constructs an updated prompt sentence that reflects the new user state and the current state of the virtual entity.

For example, the server may construct an updated prompt sentence such as:
“The user just said: ‘Let's go!’ in an excited tone. The current virtual entity is an energetic concert mascot named Sparkle. Generate a short reply line in the same style and a corresponding cheering action.”

The server inputs the updated prompt sentence into the generative AI model and obtains response behavior information that describes updated actions and utterances of the virtual entity. The server translates the response behavior information into updated visual expression information and auditory expression information by selecting appropriate animations and synthesizing corresponding speech. The server sends the updated expression information to the terminal, causing the virtual entity to react in real time.
H. Technical Effects and Improvement of Computer Technology

The server improves computer technology in several ways. By constructing prompt sentences from structured acoustic feature information, emotion information, and character string information, the server reduces the need for manual prompt engineering and enables automatic generation of context-rich prompts in real time. This reduces latency and improves computational efficiency when driving the generative AI model because the server can re-use precomputed structured data and only update changed components.

The server leverages a neural network architecture that jointly analyzes temporal acoustic patterns and textual content, thereby improving the accuracy and robustness of emotion estimation as compared with rule-based systems. The server's use of data augmentation during training improves generalization and reduces error rates when processing noisy real-world audio. As a result, the generative AI model receives more precise context, which leads to more consistent and appropriate description information and expression information.

The server uses specific data structures for structured data and expression parameter information, which permit efficient caching, incremental updates, and selective re-generation of expressions. For example, when only a subset of emotion information changes slightly, the server can adjust expression parameter information without regenerating the entire visual or auditory expression, thereby reducing computation load and network traffic.

The server's pipeline is not a mere automation of human reasoning but a non-conventional computational process that exploits machine-level operations such as high-dimensional feature extraction, neural network inference, and transformer-based sequence generation. The prompt construction module implements rules that combine numerical acoustic features and probability-based emotion information into natural-language descriptions, a process that is difficult for a human operator to perform in real time at scale. The server thereby enables a level of personalization and dynamic response that is not practically achievable by manual scripting.

The integration of event state information and expression parameter information further improves system functionality by allowing the server to adjust visual and auditory output to hardware characteristics of the event-providing display device and the acoustic device. For instance, the server may compute output levels that take into account device capabilities and environmental conditions, thereby improving overall signal quality and user experience.

Because the server, terminal, and user operate in a coordinated manner, the system achieves improved throughput in interactive content delivery: the server can process multiple user sessions concurrently using parallel execution of neural network inference on specialized hardware and can adjust communication patterns to minimize bandwidth usage by sending only differential updates to expression information when feasible.

### I. Variations and Alternative Embodiments

In another embodiment, the server may implement the generative AI model locally using a smaller transformer model optimized for lower latency, rather than relying on an external service. The server may store model weights on a graphics processing unit or other accelerator and may perform batch inference for multiple prompt sentences to further improve computational efficiency.

In a further embodiment, the server may use different neural network architectures for emotion estimation, such as a convolutional neural network applied to spectrogram images or a hybrid model that combines recurrent and attention-based layers. The server may adjust hyperparameters, including the number of layers, hidden dimension sizes, and learning rates, to trade off between accuracy and processing speed.

In another variation, the server may allow the terminal to perform preliminary feature extraction to reduce communication load. The terminal may compute low-dimensional acoustic features and transmit these features instead of raw audio data. The server may still construct prompt sentences and drive the generative AI model based on the transmitted features and any additional information, thus reducing bandwidth requirements while preserving responsiveness.

In another embodiment, the server may generate only auditory expression information, for example in an audio-only environment, or only visual expression information for environments where sound output is limited. The same structured data and prompt construction mechanisms are used to drive the generative AI model, but downstream modules select audio or visual pipelines as appropriate.

In all of these embodiments, the server, the terminal, and the user interact in a manner that allows other persons skilled in the art to implement the invention using commercially available hardware, general-purpose computing platforms, and standard communication protocols, while achieving the technical effects of improved processing accuracy, reduced latency, enhanced adaptability, and more efficient use of computational and communication resources.

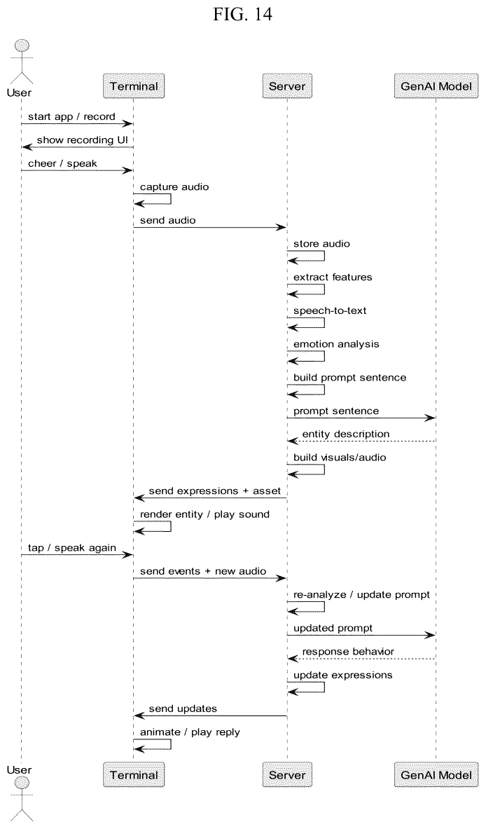

The following describes the processing flow using FIG. 14.

### Step 1

User operates the terminal to start an application and select a function for recording or interaction.

Input: User intention (for example, tapping a “Start Cheer” button).

Output: Application state indicating that audio capture is to begin.

Terminal responds by activating an audio capture component, requesting access to the microphone through an operating system API, and allocating an audio buffer in memory for incoming samples.

### Step 2

Terminal acquires sound information from the microphone and converts it into digital audio data.

Input: Analog sound waves produced by the user, such as cheers, shouts, or spoken phrases.

Output: A sequence of digital audio samples stored in a buffer (for example, 16-bit PCM at 16 kHz or higher).

Terminal samples the analog signal at a fixed sampling rate, quantizes the samples, stores them in a frame-based buffer, and writes the buffered frames into a temporary audio file or memory structure that includes metadata such as duration and sampling parameters.

### Step 3

Terminal transmits the recorded digital audio data to the server.

Input: The buffered digital audio data and associated metadata (for example, sampling rate, encoding, language hint).

Output: A network request sent to the server containing the digital audio data payload.

Terminal opens a secure connection, such as an HTTPS connection, encapsulates the audio data into a request body (for example, multipart/form-data or binary stream), attaches user/session identifiers, and sends the request to an audio processing endpoint exposed by the server.

### Step 4

Server receives and stores the digital audio data.

Input: Network packets containing the digital audio data and metadata.

Output: A stored audio object and a reference identifier in server storage.

Server reconstructs the audio stream from the packets, validates the format and size, writes the audio data into a storage area (for example, as a file or a database BLOB), and generates an internal audio ID that is used to link subsequent analysis results to this particular recording.

### Step 5

Server performs audio feature extraction to obtain acoustic feature information.

Input: The stored digital audio data identified by the audio ID.

Output: Acoustic feature information represented as one or more feature vectors over time.

Server loads the audio data into an audio analysis library, segments the waveform into overlapping frames, and computes features for each frame, such as pitch, energy, spectral centroid, spectral bandwidth, and zero-crossing rate. Server normalizes or scales these feature values, aggregates them into a structured feature matrix, and stores the result as acoustic feature information linked to the audio ID.

### Step 6

Server performs speech-to-text processing to generate character string information.

Input: The same digital audio data that was used for feature extraction.

Output: Recognized text and optional confidence scores stored as character string information.

Server sends the audio data to a speech recognition engine, sets recognition parameters (such as language code), and receives recognized words or phrases. Server filters or segments the recognized output, attaches time stamps if available, and stores the text and scores in association with the audio ID.

### Step 7

Server estimates emotion information from acoustic feature information and character string information.

Input: Acoustic feature information and character string information.

Output: Emotion information including at least one emotion label and a numerical intensity or probability value.

Server feeds the acoustic feature matrix into a trained neural network classifier, computes output probabilities for multiple emotion categories, and selects a dominant emotion or a distribution of emotions. Server optionally performs sentiment analysis on the recognized text and combines text-based and audio-based estimates using a fusion rule (for example, weighted averaging), then stores the resulting emotion information with the audio ID.

### Step 8

Server constructs structured data that summarizes the analysis results.

Input: Acoustic feature information, emotion information, and character string information.

Output: A structured data object that contains fields for voice color, emotion, and recognized text.

Server transforms raw feature vectors into high-level voice-color descriptors (for example, “high pitch”, “strong intensity”), packages these descriptors together with emotion labels and recognized words into a predefined schema, such as a record with named fields, and stores this structured data for use by the prompt construction logic.

### Step 9

Server generates a prompt sentence for a generative AI model based on the structured data.

Input: Structured data containing voice-color descriptors, emotion information, and recognized text.

Output: A natural-language prompt sentence describing the generation request.

Server fills predetermined prompt templates with values extracted from the structured data. For example, server may generate a prompt sentence such as “User's cheer: ‘Awesome!’. Voice color: high pitch, loud, fast tempo. Emotion: strong joy. Event type: live concert. Please generate an energetic mascot character who cheers together with the user and fits a live concert setting.” Server outputs this text as a prompt sentence ready for use by the generative AI model.

### Step 10

Server inputs the prompt sentence to a generative AI model and obtains description information of a virtual entity.

Input: The generated prompt sentence and any control parameters (for example, sampling temperature, maximum output length).

Output: Description information of a virtual entity expressed as generated text.

Server tokenizes the prompt sentence, feeds the token sequence into the generative AI model, and runs inference to generate continuation tokens. Server decodes the token sequence into text that describes the virtual entity's appearance, personality, behaviors, and dialogue, then stores this text as description information associated with the current session.

### Step 11

Server parses and structures the description information.

Input: Textual description information generated by the generative AI model.

Output: A structured representation of virtual entity attributes.

Server applies a parsing algorithm (for example, rule-based extraction or another language model used as a parser) to identify attributes such as color, size, motion patterns, and typical phrases. Server organizes these attributes into a data structure, such as an entity profile object, and saves it for use by expression generation and digital asset creation.

### Step 12

Server generates visual expression information and auditory expression information of the virtual entity.

Input: The structured virtual entity attributes and emotion information.

Output: Visual expression information (for example, model ID, texture references, animation commands) and/or auditory expression information (for example, synthesized voice clips).

Server matches the entity attributes to base templates in a character library, selects a suitable model, and applies parameter changes to colors, poses, and motion amplitude based on the attributes and emotion intensity. Server constructs a visual descriptor that references the selected model and animation sequences. For audio, server may form a short cheering text derived from the entity's dialogue, call a text-to-speech engine with voice parameters derived from the user's voice-color and emotion, and store synthesized audio as auditory expression information.

### Step 13

Server determines expression parameter information according to the state of event-providing content.

Input: Description information of the virtual entity, emotion information, and event state information (for example, whether a scene is calm or in a climax).

Output: Expression parameter information specifying how visual and auditory expressions should be adjusted.

Server computes parameters such as brightness level, motion speed, and audio volume by combining emotion intensity with event state (for example, increasing brightness and motion speed when both emotion and event intensity are high). Server encapsulates these parameters into an expression parameter object that directs how to render the virtual entity in the current context.

### Step 14

Server applies the expression parameter information to finalize expression data and prepares them for transmission.

Input: Preliminary visual and auditory expression information and expression parameter information.

Output: Updated visual expression information and auditory expression information tailored for a specific display device and acoustic device.

Server adjusts animation playback rates, scales visual intensity (for example, particle effects or glow), and sets audio gain or equalization settings according to the expression parameter values. Server packages the final expression information into a format compatible with the terminal's rendering engine and audio playback system.

### Step 15

Server generates digital asset information corresponding to the virtual entity.

Input: The structured virtual entity attributes, initial audio analysis results, and session/user identifiers.

Output: Digital asset information including a unique asset identifier and metadata.

Server compiles a metadata record describing the virtual entity, including origin data such as the user's cheer, emotion profile, and generation time. Server assigns a unique identifier to the asset, stores it in a digital asset database, and links it to the user's account. The resulting digital asset information is prepared for transmission to the terminal.

### Step 16

Server transmits expression information and digital asset information to the terminal.

Input: Updated visual expression information, auditory expression information, and digital asset information.

Output: A response message delivered to the terminal containing all necessary data for presentation and asset management.

Server constructs a response payload, for example in a structured message format, embeds references to graphical and audio resources, and includes the asset identifier and metadata. Server sends this payload over the established network connection to the terminal.

### Step 17

Terminal receives and interprets the expression information and digital asset information.

Input: The response payload from the server containing visual expression information, auditory expression information, and digital asset metadata.

Output: Internal data structures ready for rendering and playback, and updates to the user's asset collection.

Terminal parses the payload, stores the asset identifier and metadata in local storage, and maps visual descriptors to drawable resources and animation controllers. Terminal prepares audio clips or streams for playback and updates any user interface elements that list owned or available digital assets.

### Step 18

Terminal renders the virtual entity and outputs auditory expressions based on the received information.

Input: Visual expression information, auditory expression information, and expression parameter information embedded in the response.

Output: A displayed virtual entity on the terminal display and optionally sound output through the acoustic device.

Terminal invokes its rendering engine to load textures and models referenced in the visual expression information, positions the virtual entity on the screen, and runs specified animations at the indicated speed. Terminal simultaneously plays associated audio clips through speakers or headphones, adjusting volume and timing to match the animation and event state.

### Step 19

User interacts with the displayed virtual entity through operation inputs and additional speech.

Input: Visual representation and auditory output as perceived by the user.

Output: User actions such as taps, swipes, button presses, or spoken responses.

User may tap on the virtual entity to trigger a reaction, drag it across the screen, or speak additional phrases such as “Let's go!” or “One more time!”. These interactions form new operation information and additional sound information to be captured by the terminal.

### Step 20

Terminal captures operation information and additional sound information and sends them to the server.

Input: User interaction events (touch coordinates, event types) and new audio samples from the microphone.

Output: An interaction request sent to the server containing operation information and, if present, newly recorded digital audio data.

Terminal logs each interaction event with timestamps and contextual identifiers, starts a short audio recording session if the user speaks, encodes the recorded audio as digital audio data, and wraps both the event data and audio data into a request that is transmitted to the server.

### Step 21

Server updates analysis and constructs an updated prompt sentence for the generative AI model.

Input: Operation information, additional digital audio data, and previous structured data.

Output: An updated structured data object and an updated prompt sentence reflecting the new context.

Server analyzes the additional audio as in earlier steps to obtain new acoustic feature information, character string information, and emotion information. Server merges these with existing structured data, taking into account the current virtual entity state and the type of operation performed (for example, a tap versus a long press). Server then constructs an updated prompt sentence such as “The user just said: ‘Let's go!’ in an excited tone. The current virtual entity is an energetic concert mascot that is already cheering. Generate a short reply and a more intense cheering action.” This updated prompt sentence is prepared for a new generative AI model invocation.

### Step 22:

Server invokes the generative AI model again to generate response behavior information of the virtual entity.

Input: The updated prompt sentence and current entity state information.

Output: Response behavior information specifying new actions, expressions, and dialogue of the virtual entity.

Server sends the updated prompt sentence to the generative AI model, obtains generated text that describes how the virtual entity should respond, and parses this text into structured behavior commands (for example, “jump higher”, “wave both arms”, “shout ‘We can do it!’”). Server stores these commands as response behavior information.

### Step 23

Server converts response behavior information into updated expression information and sends it to the terminal.

Input: Response behavior information and current visual and auditory expression information.

Output: Updated visual expression information and updated auditory expression information transmitted to the terminal.

Server maps behavior commands to concrete animation sequences and sound playback instructions, updates the expression parameter information if necessary, and constructs a differential update message that includes only the changes from the prior state to minimize bandwidth. Server sends this update to the terminal, causing the virtual entity to respond in real time to the user's latest actions.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

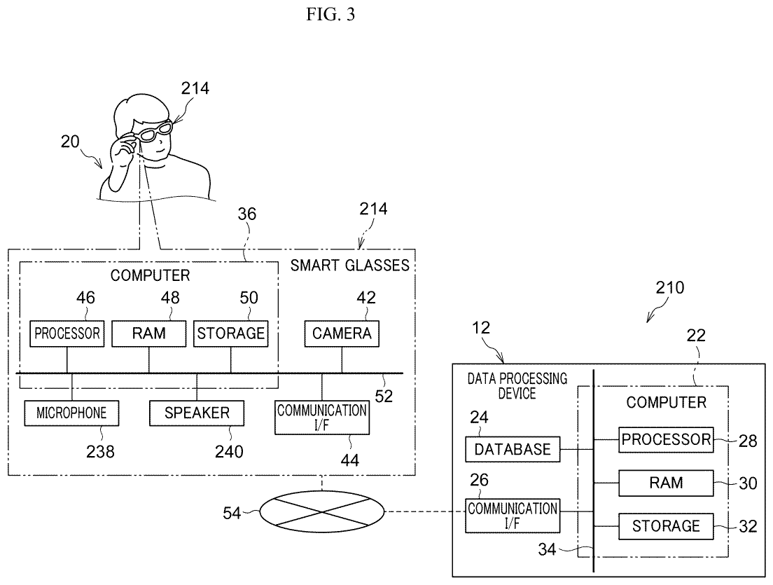

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

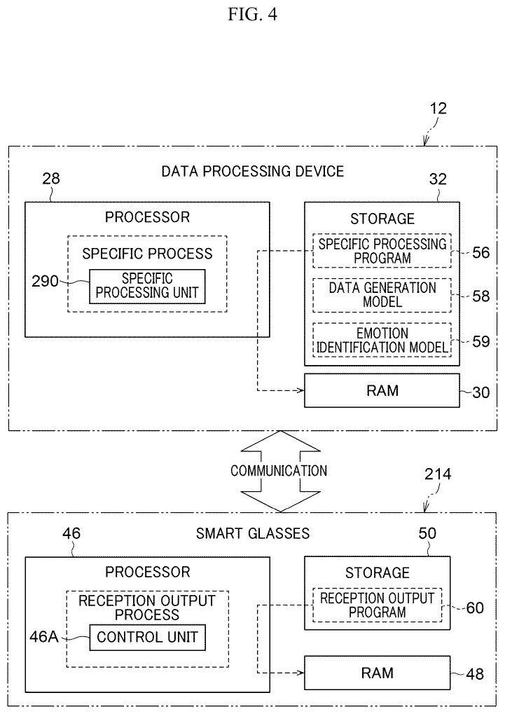

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

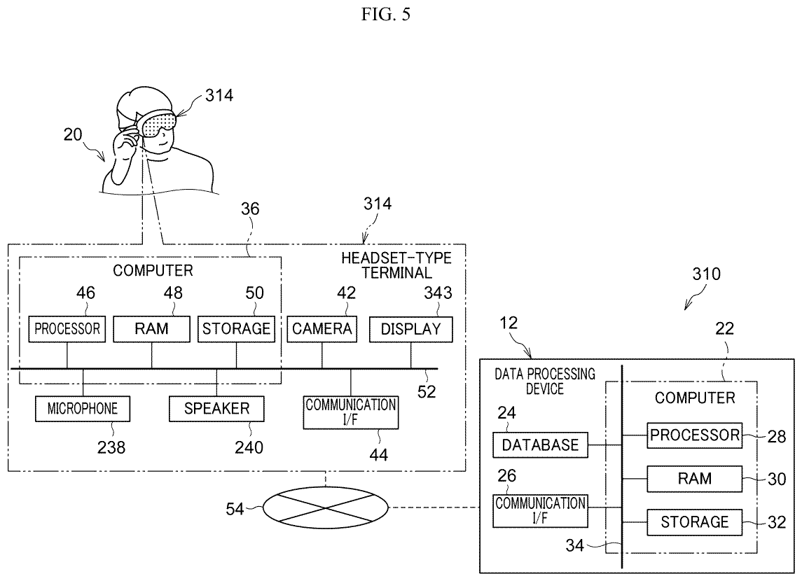

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

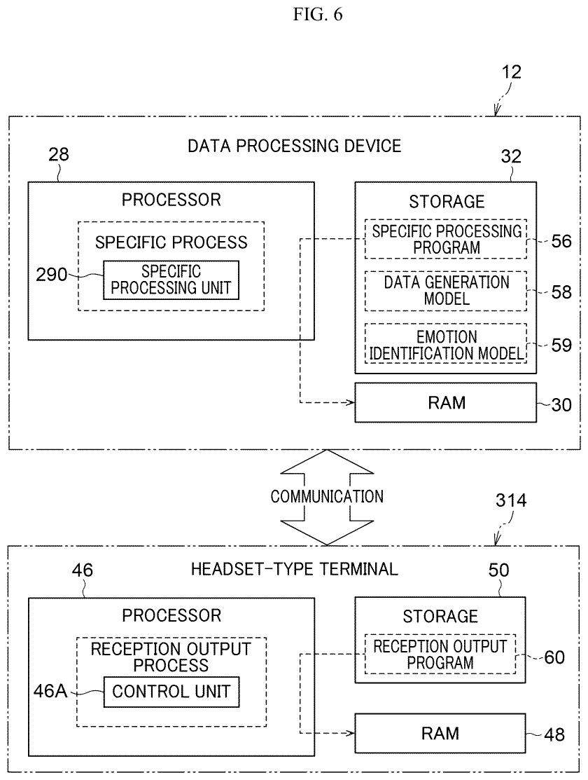

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

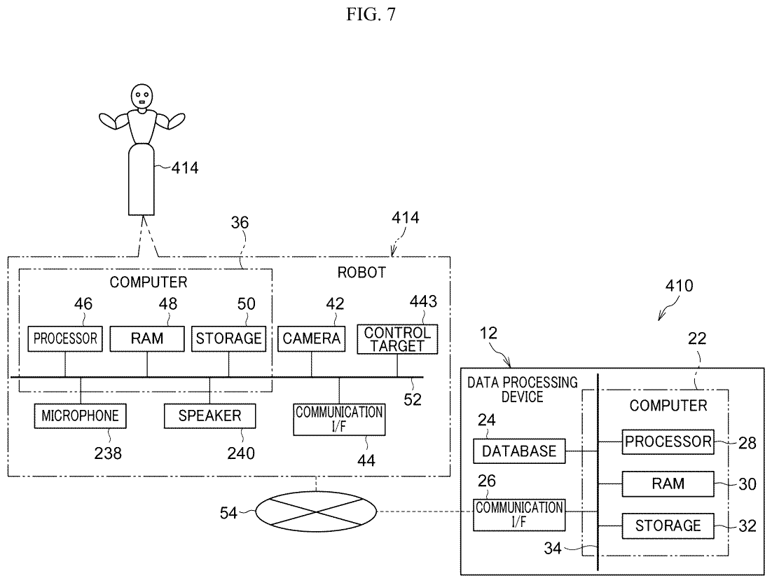

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

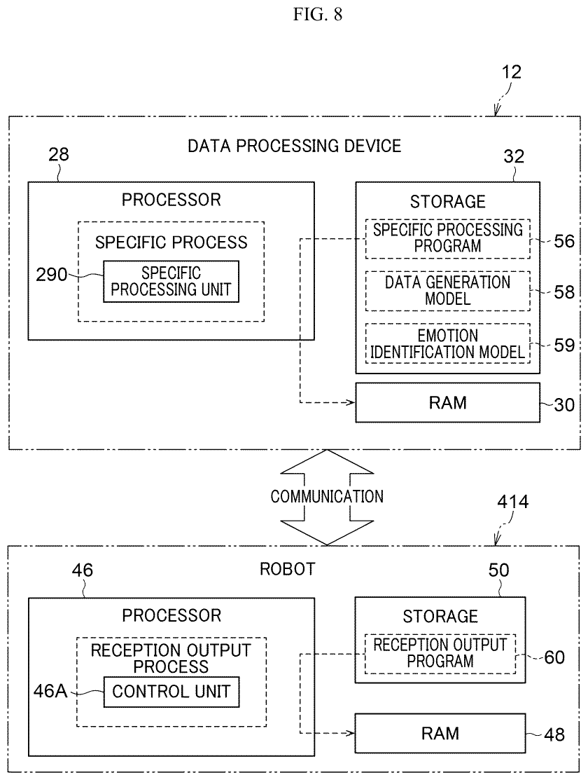

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

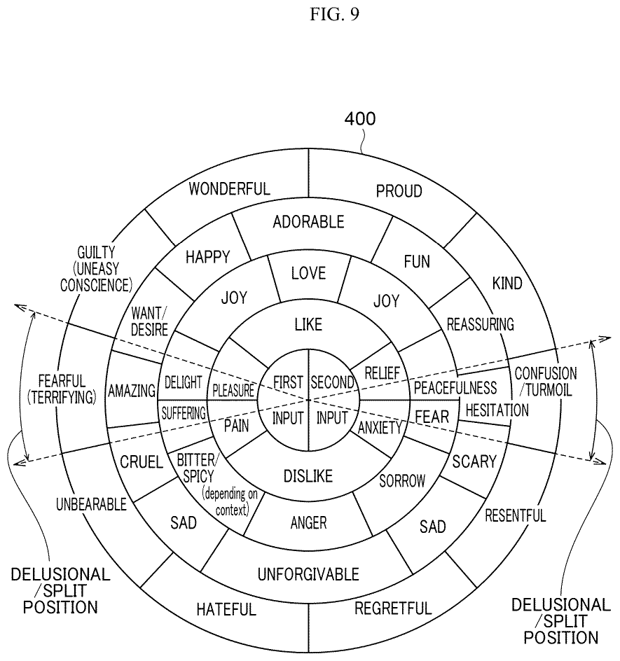

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

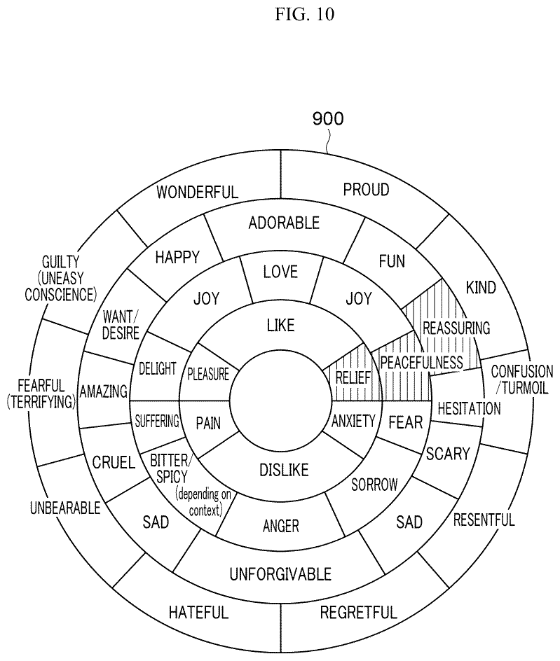

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to
receive, via a communication path, request information including a prompt sentence and associated condition information from a user terminal, the prompt sentence being accepted as character information and the request information being structured based on the prompt sentence,
preprocess the prompt sentence included in the request information by using natural language processing to convert the prompt sentence into a token sequence and numerical representation, and supply the token sequence and the numerical representation, as generation input data, to a generative artificial intelligence model,
execute the generative artificial intelligence model on an information processing apparatus to generate, based on the generation input data, an audio signal including acoustic waveform data corresponding to a crowd cheer by machine learning, and acquire the audio signal as digital audio data,
apply a signal processing algorithm to the audio data to analyze at least one of frequency characteristics, sound pressure level, dynamic range, and noise components, and execute at least one of filtering processing, dynamic range compression processing, equalization processing, noise reduction processing, and volume normalization processing, thereby generating processed audio data whose acoustic quality is corrected,
encode the processed audio data in accordance with a predetermined encoding scheme or convert the processed audio data into a storage format, and transmit, to the user terminal, response information including the processed audio data and attribute information of the processed audio data, and
output the processed audio data in a format capable of being supplied to an acoustic output apparatus provided by the user terminal so as to radiate, via the acoustic output apparatus into a predetermined space, sound that imitates the crowd cheer.

### (Supplementary 2)

The system according to supplementary 1,
wherein the processor is configured to perform the preprocessing by performing semantic analysis on the prompt sentence to extract at least one of event type information, temporal transition information, emotional intensity information, and audience reaction type information, and by adding an analysis result as a control parameter for the generative artificial intelligence model so as to cause generation of cheering audio data having temporal variation and intensity variation corresponding to semantic content of the prompt sentence.

### (Supplementary 3)

The system according to supplementary 1,
wherein the processor is configured to operate the signal processing algorithm based on acoustic field conditions assumed for reproduction of the processed audio data by an acoustic apparatus installed in a public space, and to automatically adjust at least one of a frequency band and a sound pressure level in accordance with acoustic characteristic information of a reproduction space so as to optimize the processed audio data to provide cheering sound with enhanced presence in the public space.

### Application Example 1

### (Supplementary 1)

A system comprising a processor,
wherein the processor is configured to
acquire reaction information transmitted from viewers via a communication network and store the reaction information in time series as accumulated reaction information,
analyze the accumulated reaction information by using natural language processing to calculate, for each piece of the reaction information, an emotion index and to generate, by aggregating the emotion indexes within a predetermined time period, an aggregate index indicating a crowd excitement level,
generate, on the basis of the aggregate index, a prompt sentence indicating a scale and a temporal transition of a crowd cheer, input the prompt sentence into a generative information processing model, and obtain, from the generative information processing model, generation result information describing characteristics of an audio signal that imitates a crowd cheer, select, on the basis of the generation result information, a plurality of pre-recorded crowd audio sources, set, as parameters according to the characteristics, at least a time length, a volume level, a frequency characteristic, and a mixing ratio, and perform signal processing to mix the plurality of crowd audio sources so as to generate cheer audio data,
associate the cheer audio data with a predetermined time position of at least one of a distribution target audio-video signal and a recorded audio-video signal, and integrate the cheer audio data into the audio-video signal so as to generate distribution media data for a plurality of terminals, and
transmit the distribution media data to the terminals and control playback at the terminals such that the cheer audio data is reproduced to provide an immersive viewing experience to users.

### (Supplementary 2)

The system according to supplementary 1,
wherein the processor is configured to
construct the prompt sentence so as to include, in accordance with the aggregate index, at least a cheer intensity category, a cheer duration category, and a cheer component category, and convert the generation result information obtained from the generative information processing model into a parameter sequence interpretable by an audio synthesis function that mixes the plurality of pre-recorded crowd audio sources.

### (Supplementary 3)

The system according to supplementary 1,
wherein the processor is configured to
apply signal processing to the cheer audio data to dynamically adjust, in accordance with acoustic conditions of at least one of an event venue and a remote viewing environment, at least a volume level, a reverberation characteristic, a frequency characteristic, and a spatial arrangement of the cheer audio data, and to control the cheer audio data such that, when mixed with other audio components included in the distribution media data, audibility and a sense of presence of the cheer audio data fall within a predetermined range.

### Example 2

### (Supplementary 1)

A system comprising a processor,
wherein the processor is configured to
acquire sound from a subject and record the sound as a digital signal by using an input unit,
perform frequency analysis and time-domain analysis on the digital signal recorded by the input unit to extract voice-color feature quantities including at least pitch, sound pressure, frequency spectrum, and temporal variation by using an analysis unit,
determine attribute information indicating an impression of the sound based on the voice-color feature quantities extracted by the analysis unit, and generate a prompt sentence including the attribute information and the voice-color feature quantities, the prompt sentence being configured as an instruction sentence for generation processing, by using a prompt-generation unit,
receive the prompt sentence generated by the prompt-generation unit as input, and generate data including character data by using a generative information-processing model based on the prompt sentence, by using a data-generation unit, and
convert the character data generated by the data-generation unit into image data or display data, and visually present the character data on a display device, by using a display unit.

### (Supplementary 2)

The system according to supplementary 1,
wherein the processor is configured to
divide the digital signal into a plurality of time segments, apply a window function to each of the time segments, execute a fast Fourier transform on each of the time segments to calculate a frequency spectrum, calculate a plurality of numerical feature quantities including at least a fundamental frequency, a sound-pressure level, and a spectral centroid based on the frequency spectrum and the digital signal by using the analysis unit, and apply a rule or a classification model to the numerical feature quantities to determine an impression category of the sound, and generate, by using the prompt-generation unit, the prompt sentence described in natural language including the impression category and the numerical feature quantities.

### (Supplementary 3)

The system according to supplementary 1,
wherein the processor is configured to
input text data including the prompt sentence to the generative information-processing model, execute, by using the data-generation unit, sequential inference processing or probabilistic generation processing conditioned on the prompt sentence in the generative information-processing model to generate the character data including at least appearance information and personality information of a character corresponding to the prompt sentence, and cause the display unit to generate and display an image including the appearance information of the character based on the character data.

### Application Example 2

### (Supplementary 1)

A system comprising a processor,
wherein the processor is configured to
acquire sound information of a subject and store the sound information as digital audio data, analyze the acquired sound information to identify acoustic feature information and emotion information,
construct a prompt sentence on the basis of the acoustic feature information and the emotion information, input the prompt sentence to a generative AI model, and generate description information of a virtual entity by using the generative AI model,
generate visual expression information or auditory expression information of the virtual entity on the basis of the description information of the virtual entity,
generate digital asset information corresponding to the virtual entity and distribute the digital asset information to an information processing terminal,
update the prompt sentence for the generative AI model in response to operation information or additional sound information received from the information processing terminal, and
generate response behavior information of the virtual entity on the basis of the updated prompt sentence, and
update the visual expression information or the auditory expression information on the basis of the response behavior information and present updated expression information to the information processing terminal or to a display device.

### (Supplementary 2)

The system according to supplementary 1,
wherein the processor is configured to
generate structured data including the acoustic feature information, the emotion information, and character string information obtained from the sound information, and convert the structured data into the prompt sentence in a natural language form to be input to the generative AI model.

### (Supplementary 3)

The system according to supplementary 1,
wherein the processor is configured to
determine expression parameter information in accordance with a state of event-providing content on the basis of the description information of the virtual entity and the emotion information, and generate the visual expression information or the auditory expression information in a form suitable for an event-providing display device or an acoustic device in accordance with the expression parameter information.

What is claimed is:

1. A system comprising:
a communication interface coupled to a packet-switched network; and
circuitry configured to:
receive, via the communication interface, request information from a terminal device, the request information comprising a prompt and associated condition information;
preprocess the prompt by executing natural language processing to convert the prompt into a token sequence and a numerical representation, and supply the token sequence and the numerical representation as generation input data to a generative neural network model;
execute the generative neural network model to generate, based on the generation input data, an audio signal comprising acoustic waveform data, and acquire the audio signal as digital audio data;
apply a signal processing algorithm to the digital audio data to analyze at least one of frequency characteristics, sound pressure level, dynamic range, and noise components, and execute at least one of filtering processing, dynamic range compression processing, equalization processing, noise reduction processing, and volume normalization processing to generate processed audio data; and
encode the processed audio data in accordance with a predetermined encoding scheme and transmit, to the terminal device via the packet-switched network, response information comprising the processed audio data and attribute information of the processed audio data.

2. The system according to claim 1, wherein the natural language processing comprises tokenization, part-of-speech tagging, and named-entity recognition to extract semantic parameters from the prompt, the semantic parameters comprising at least intensity level, emotional tone classification, and duration specification.

3. The system according to claim 2, wherein the circuitry is further configured to map the semantic parameters to generation control vectors that condition the generative neural network model, the generation control vectors comprising numerical values for amplitude envelope shape, spectral distribution target, and temporal pattern specification.

4. The system according to claim 3, wherein the generative neural network model comprises a neural network trained on audio waveform data to generate acoustic signals conditioned on input control vectors, the neural network implementing at least embedding layers, attention layers, and waveform synthesis layers.

5. The system according to claim 4, wherein the waveform synthesis layers comprise a vocoder module that converts mel-spectrogram representations output by the attention layers into time-domain audio samples at a predetermined sampling rate.

6. The system according to claim 5, wherein the circuitry is further configured to apply a post-processing pipeline to the time-domain audio samples comprising high-pass filtering to remove sub-audible components, peak limiting to constrain maximum amplitude, and dithering prior to quantization.

7. The system according to claim 1, wherein the signal processing algorithm comprises an equalization process that adjusts frequency band gains based on acoustic environment parameters received from the terminal device, the acoustic environment parameters comprising room dimensions, reverberation time, and speaker placement coordinates.

8. The system according to claim 7, wherein the circuitry is further configured to generate an inverse filter response based on the acoustic environment parameters and to convolve the digital audio data with the inverse filter response to produce the processed audio data compensated for the acoustic environment.

9. The system according to claim 8, wherein the dynamic range compression processing comprises a multi-band compressor that independently controls gain reduction across a plurality of frequency bands using threshold, ratio, attack time, and release time parameters derived from the condition information.

10. The system according to claim 1, wherein the circuitry is further configured to receive, from the terminal device, a plurality of prompts each specifying different audio characteristics, generate respective digital audio data for each prompt, and mix the respective digital audio data into a composite audio signal with gain and timing offsets derived from the associated condition information.

11. The system according to claim 10, wherein the mixing comprises crossfade processing between successive audio segments using an overlap-add method with window functions applied to segment boundaries.

12. The system according to claim 1, wherein the encoding scheme comprises at least one of a lossless encoding format and a lossy encoding format selectable based on a bandwidth parameter specified in the condition information, and wherein the attribute information comprises codec identifier, bit rate, sampling rate, and channel count.

13. The system according to claim 1, wherein the circuitry is further configured to receive feedback information from the terminal device indicating an evaluation of the processed audio data, and to adjust generation parameters of the generative neural network model for subsequent audio generation based on the feedback information.

14. The system according to claim 13, wherein the adjustment comprises updating preference weights stored in the storage device in association with a session identifier, and incorporating the updated preference weights into the generation control vectors for subsequent prompt processing.

15. The system according to claim 1, wherein the circuitry is further configured to analyze the digital audio data using spectral analysis to detect artifacts comprising clipping, harmonic distortion, and aliasing, and to apply corrective processing to reduce the detected artifacts prior to encoding.

16. The system according to claim 1, wherein the audio signal comprises crowd cheering audio generated to imitate cheering of a crowd at a live event, and wherein the condition information specifies at least venue type, audience size estimation, and event category.

17. The system according to claim 16, wherein the circuitry is further configured to calculate a quality metric for the processed audio data based on signal-to-noise ratio and spectral flatness, and to regenerate the audio signal when the quality metric falls below a threshold.

18. A system comprising:
a communication interface coupled to a packet-switched network; and
circuitry configured to:
receive request information from a terminal device via the communication interface, the request information comprising a prompt and condition information including acoustic environment parameters;
execute natural language processing on the prompt to extract semantic parameters comprising intensity level, emotional tone classification, and duration specification, and map the semantic parameters to generation control vectors;
execute a generative neural network model comprising embedding layers, attention layers, and waveform synthesis layers to generate acoustic waveform data conditioned on the generation control vectors, and acquire the waveform data as digital audio data;
apply signal processing to the digital audio data comprising equalization based on the acoustic environment parameters, multi-band dynamic range compression, noise reduction, and volume normalization to generate processed audio data;
encode the processed audio data in a format selected based on a bandwidth parameter in the condition information; and
transmit the processed audio data and attribute information comprising codec identifier, bit rate, sampling rate, and channel count to the terminal device via the packet-switched network.

19. The system according to claim 18, wherein the circuitry is further configured to receive feedback information from the terminal device, update preference weights stored in a storage device based on the feedback information, and incorporate the updated preference weights into the generation control vectors for subsequent prompt processing.

20. A method comprising:
receiving, by circuitry coupled to a packet-switched network, request information from a terminal device, the request information comprising a prompt and condition information;
preprocessing the prompt by executing natural language processing to convert the prompt into a token sequence and a numerical representation, and supplying the token sequence and the numerical representation as generation input data to a generative neural network model;
executing the generative neural network model to generate an audio signal comprising acoustic waveform data based on the generation input data, and acquiring the audio signal as digital audio data;
applying a signal processing algorithm to the digital audio data comprising at least one of filtering, dynamic range compression, equalization, noise reduction, and volume normalization to generate processed audio data; and
encoding the processed audio data and transmitting response information comprising the processed audio data to the terminal device via the packet-switched network.
